(19) United States
(12) Patent Application Publication
(10) Pub. No.: US 2018/0137447 A1
(43) Pub. Date: May 17, 2018

(54) ORGANIZATIONAL CHART CREATION DEVICE, ORGANIZATIONAL CHART PROVIDING SYSTEM, TRANSITION ORGANIZATIONAL CHART, METHOD FOR PROVIDING TRANSITION INFORMATION, AND NON-TRANSITORY RECORDING MEDIUM STORING COMPUTER READABLE PROGRAM

(71) Applicant: KONICA MINOLTA, INC., Tokyo (JP)

(72) Inventor: Takumi KASEDA, Tokyo (JP)

(73) Assignee: KONICA MINOLTA, INC., Tokyo (JP)

(21) Appl. No.: 15/795,759

(22) Filed: Oct. 27, 2017

(30) Foreign Application Priority Data
Nov. 11, 2016 (JP) 2016-220847

(51) Int. Cl. G06Q 10/06; G06F 17/30

(52) U.S. Cl. CPC G06Q 10/06313; G06F 17/30979

(57) ABSTRACT

An organizational chart creation device includes a hardware processor configured to create a transition organizational chart, the transition organizational chart including: a first organizational chart having first identifiers of first persons, who are in any of departments during a first period of time, classified and arranged according to department; a second organizational chart having second identifiers of second persons, who are in any of the departments during a second period of time, classified and arranged according to department; and a linking image for associating the first identifier and the second identifier with each other of a first person of the first persons and a second person of the second persons, said first person being identical to said second person, and to output the transition organizational chart.

Japanese Patent application No. 2016-220847 filed on Nov. 11, 2016, including description, claims, drawings, and abstract of the entire disclosure is incorporated herein by reference in its entirety.

### BACKGROUND

### 1. Technological Field

The present invention relates to a technology for creating an organizational chart.

### 2. Description of the Related Art

An organizational chart is used to show relations between departments provided in a current organization or relations between people working in the departments of the organization. As organizational chart-related technologies, the following technologies have been proposed.

According to one of the technologies, an information processor includes a storage part for associating identification information on each person with history information of the person and with organization information including an organizational chart of an organization to which the person belongs to store them in each person, a CPU displays a history timeline display showing history information of an object person to be an object, and an organizational chart showing the organization to which the object person belongs, the history information including identification information of other persons relating to each history item, and the CPU displays history items on the history timeline display and the personnel on the organizational chart related to the history items to display them on the basis of the identification information included in the history information (English abstract of Japanese Laid-open Patent Publication No. 2014-119855).

According to the other technology, a title data setting portion holds a title code, a title name, and so on, and an individual information data setting portion holds a name, a sex, an age, the title code, a transfer history information, and so on. A processing portion displays an organizational chart on an image display portion by referring to title data and individual information data. Personnel changes information is inputted through an input portion on the display screen, and is stored, in order, into a transfer information storage portion for each personnel changes source (Japanese Laid-open Patent Publication No. 7-021269).

As being different from such an organizational chart, the following technology has been proposed for searching for a person relevant to a specific person and displaying the result of the search.

According to the technology, in a system for supporting an organization activity, an item information DB in a server computer stores item information including the identifiers of item participants. A personal information DB stores a plurality of pieces of personal attribute information in each organization individual. A personal relationship retrieving part responds to a user's retrieval request through a client terminal, retrieves item information matching a retrieving condition, extracts item participants in the information as persons with experience, retrieves personal information for each of the extracted persons with experience and a user from the personal information DB, extracts the user and the expert having at least one common attribute information, and transmits the extracted contents to a client terminal to display them (English abstract of Japanese Laid-open Patent Publication No. 2007-004504).

In the meantime, a person who would like to contact a specific person of another company sometimes searches for the specific person in an organizational chart of that another company. Even if the specific person is found by searching in the organizational chart, it is difficult for the person to contact the specific person without some kind of connection between the person and a department which the specific person works in.

### SUMMARY

The present invention has been achieved in light of such a problem, and therefore, an object of an embodiment of the present invention is to find a method which enables a user to use an organizational chart to contact someone more easily than with the conventional methods.

To achieve at least one of the abovementioned objects, according to an aspect of the present invention, an organizational chart creation device reflecting one aspect of the present invention includes a hardware processor configured to create a transition organizational chart, the transition organizational chart including: a first organizational chart having first identifiers of first persons, who are in any of departments during a first period of time, classified and arranged according to department; a second organizational chart having second identifiers of second persons, who are in any of the departments during a second period of time, classified and arranged according to department; and a linking image for associating the first identifier and the second identifier with each other of a first person of the first persons and a second person of the second persons, said first person being identical to said second person, and to output the transition organizational chart.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an example of the overall configuration of an organizational chart creation system.

FIG. 2 is a diagram showing an example of the hardware configuration of an organizational chart creation server.

FIG. 3 is a diagram showing an example of the functional configuration of an organizational chart creation server.

FIG. 4 is a diagram showing an example of the functional configuration of a business card DB server.

FIG. 5 is a diagram showing an example of personal data.

FIG. 6 is a diagram showing an example of change data.

FIG. 7 is a flowchart depicting an example of the flow of transition organizational chart creation processing.

FIGS. 8A-8C are diagrams showing examples of a configuration table.

FIG. 9 is a flowchart depicting an example of the flow of configuration table creation processing.

FIG. 10 is a diagram showing an example of a format of an organizational chart.

FIG. 11 is a flowchart depicting an example of the flow of current generation organizational chart creation processing.

FIG. 12 is a diagram showing an example of the course of creation of a current generation organizational chart.

FIG. 13 is a diagram showing an example as to how to put a current generation organizational chart in an entire area.

FIG. 14 is a flowchart depicting an example of the flow of other generation organizational chart creation processing.

FIG. 15 is a diagram showing an example as to how to put a node image for a remaining person in an entire area.

FIG. 16 is a diagram showing an example as to how to put a node image for a transferred person in an entire area.

FIG. 17 is a diagram showing an example as to how to adjust positions of node images of a particular generation.

FIG. 18 is a diagram showing an example as to how to adjust positions of node images of the next generation.

FIG. 19 is a diagram showing an example as to how to put a first area, a second area, and a third area of a particular generation in an entire area.

FIG. 20 is a diagram showing an example as to how to put an organizational chart in an entire area.

FIG. 21 is a diagram showing an example of a transition organizational chart.

FIG. 22 is a flowchart depicting an example of the flow of the entire processing by an organizational chart creation server.

FIG. 23 is a diagram showing examples of personal data and change information for the case where a change is made to a department name.

FIG. 24 is a diagram showing an example of a transition organizational chart in which first areas are connected to each other and second areas are connected to each other.

FIG. 25 is a diagram showing an example of a transition organizational chart including an organizational chart for an omissible generation.

FIGS. 26A and 26B are diagrams showing an example of a transition organizational chart with an organizational chart for an omissible generation omitted.

FIGS. 27A and 27B are diagrams showing an example of a transition organizational chart with an organizational chart for an omissible generation omitted.

### DETAILED DESCRIPTION OF EMBODIMENTS

Hereinafter, one or more embodiments of the present invention will be described with reference to the drawings. However, the scope of the invention is not limited to the disclosed embodiments.

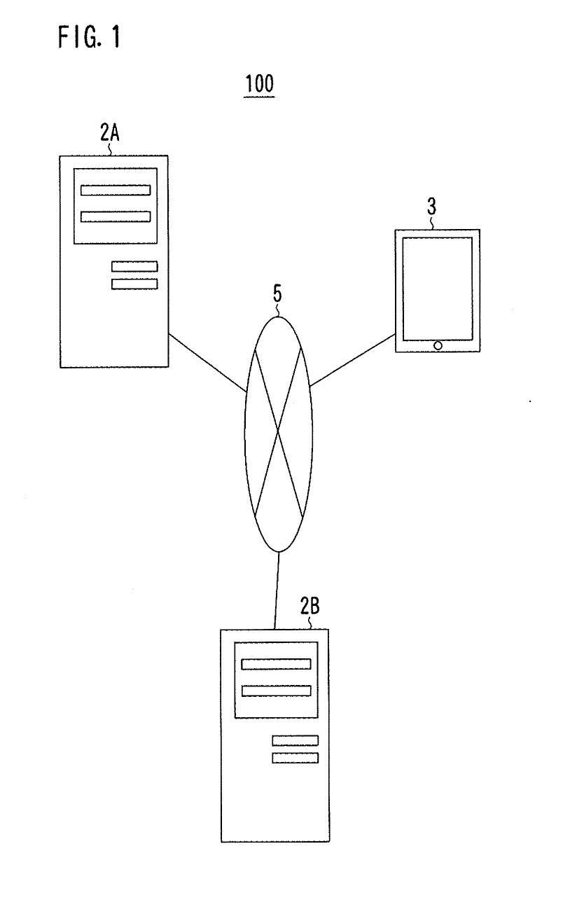

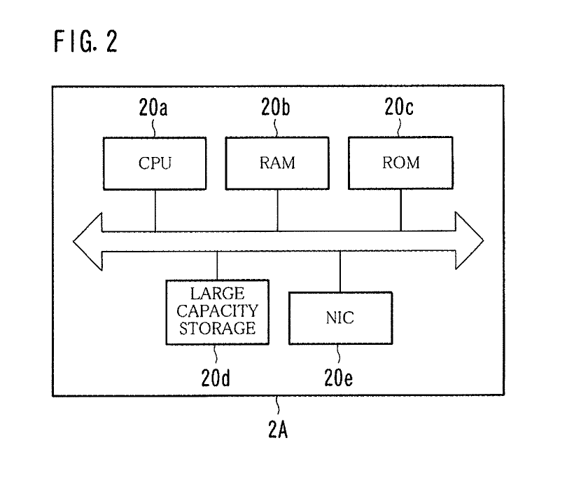

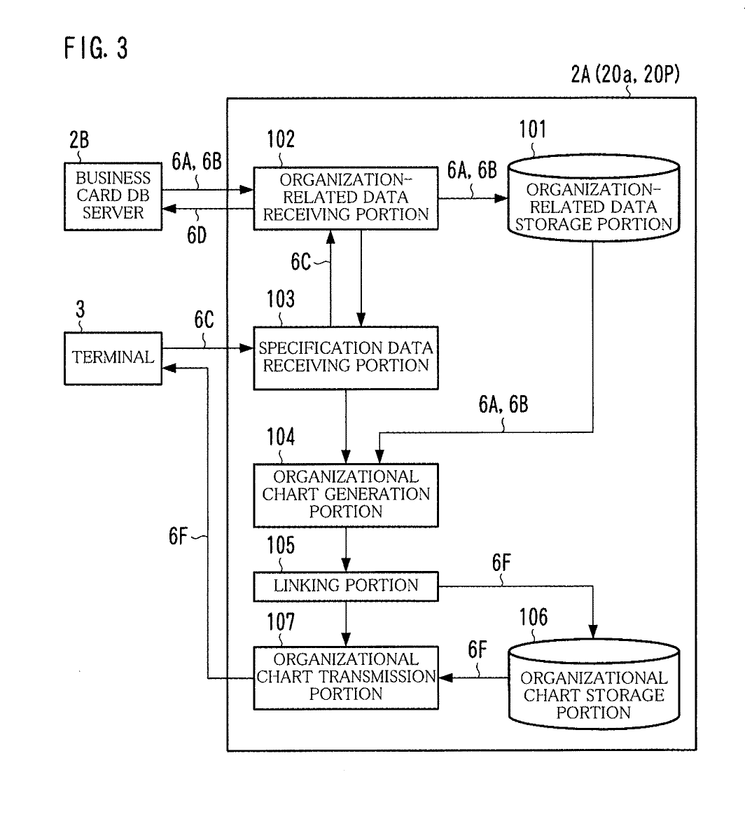

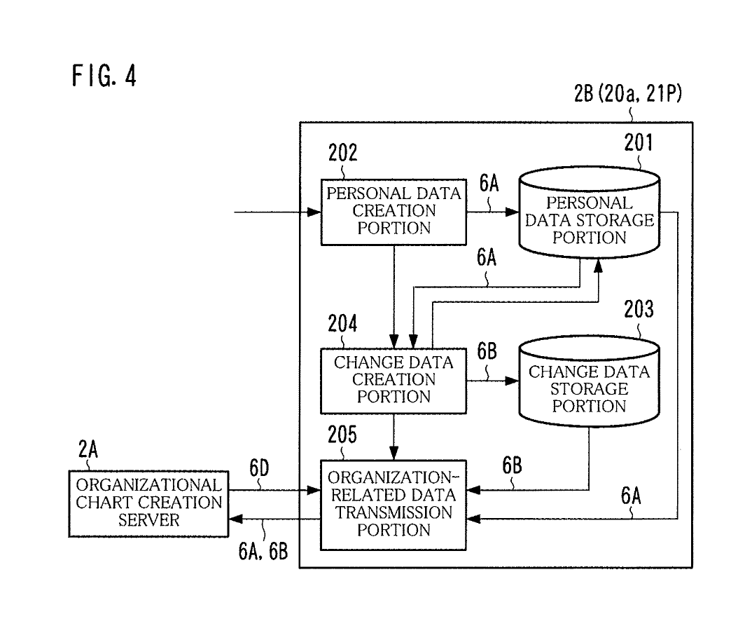

FIG. 1 is a diagram showing an example of the overall configuration of an organizational chart creation system 100. FIG. 2 is a diagram showing an example of the hardware configuration of an organizational chart creation server 2A. FIG. 3 is a diagram showing an example of the functional configuration of the organizational chart creation server 2A. FIG. 4 is a diagram showing an example of the functional configuration of a business card DB server 2B.

Referring to FIG. 1, the organizational chart creation system 100 is configured of the organizational chart creation server 2A, the business card DB server 2B, a terminal 3, a communication line 5, and so on.

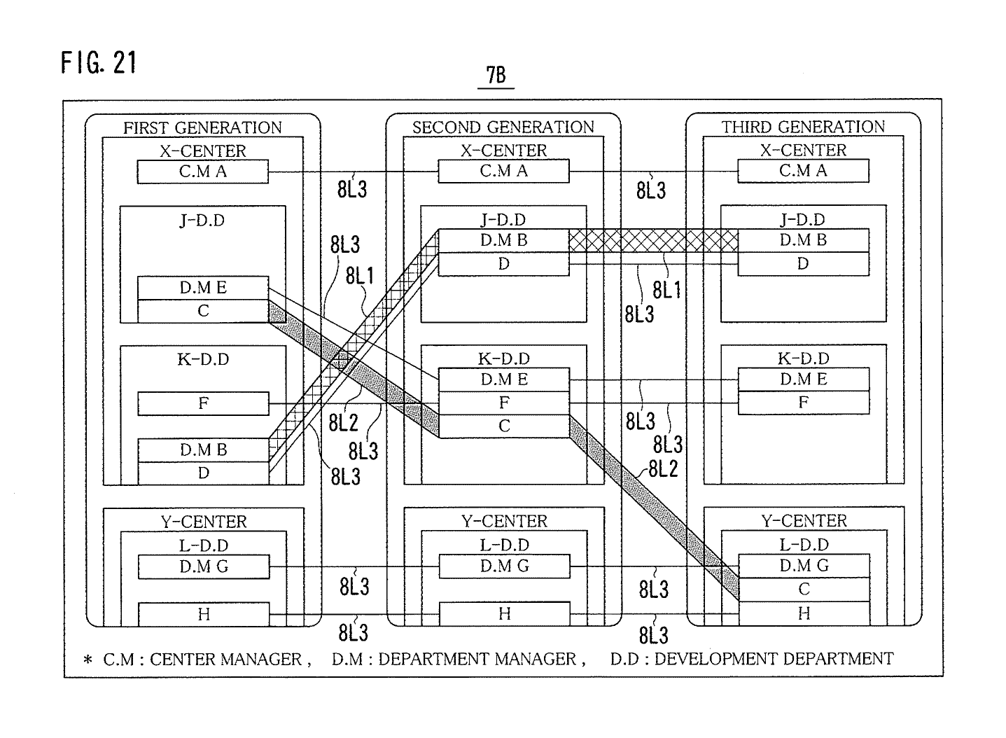

The organizational chart creation system 100 is to create a transition organizational chart 7B to provide the transition organizational chart 7B to a user. As described later with reference to FIG. 21, the transition organizational chart 7B is a chart in which organizational charts 7A, different in period, of an organization are placed side by side and names of a person who appears in the individual organizational charts 7A, namely, person names, are connected to one another with a line or a ribbon.

The organizational chart creation server 2A, the business card DB server 2B, and the terminal 3 are configured to perform communication with one another via the communication line 5. Examples of the communication line 5 include the Internet, a Local Area Network (LAN), a public line, and a dedicated line.

The organizational chart creation server 2A creates the transition organizational chart 7B in response to a request from the terminal 3 and sends the transition organizational chart 7B to the terminal 3.

Referring to FIG. 2, the organizational chart creation server 2A is configured of a Central Processing Unit (CPU) 20a, a Random Access Memory (RAM) 20b, a Read Only Memory (ROM) 20c, a large capacity storage 20d, a Network Interface Card (NIC) 20e, and so on.

The ROM 20c or the large capacity storage 20d stores, therein, a transition organizational chart creation program 20P (see FIG. 3). The large capacity storage 20d is, for example, a hard disk drive or a Solid State Drive (SSD). The transition organizational chart creation program 20P is loaded into the RAM 20b and is executed by the CPU 20a. The transition organizational chart creation program 20P is detailed later.

The business card DB server 2B is a server that stores information on different people and provide such information on request basis. The information includes, for each person, the person's name, contact information, organization (company or affiliation, for example) and department which the person is in. In short, the information is similar to the one usually included in a business card.

The hardware configuration of the business card DB server 2B is basically the same as that of the organizational chart creation server 2A as shown in FIG. 2. It is noted, however, that the large capacity storage 20d of the business card DB server 2B stores a business card management program 21P therein. The business card management program 21P is detailed later.

The terminal 3 is a client for the user to receive the organizational chart 7B. The terminal 3 has installed a web browser therein. The terminal 3 is, for example, a personal computer, a smartphone, a wearable terminal, or a tablet computer. Hereinafter, a case is described in which the terminal 3 is a tablet computer.

The organizational chart creation system 100 enables creation of an organizational chart (transition organizational chart 7B) by means of which the user can find a way to contact a specific person more easily than with the conventional methods. The description goes on to a mechanism thereof by taking an example in which a user, who is an employee of a β-company, uses the organizational chart creation system 100 to create a transition organizational chart 7B of an α-company.

The α-company has two business sites having location names of “X-center” and “Y-center”. Each of the business sites has one or more departments. In the α-company, organizational change (personnel change, change in department name, etc.) is made, as appropriate, on January 1^{st}. Information on individuals working in the α-company, namely, information indicated in personal data 6A described later, is provided to the business card DB server 2B every year regardless of whether the individuals got transferred or not.

The transition organizational chart creation program 20P implements, in the organizational chart creation server 2A, the functions of an organization-related data storage portion 101, an organization-related data receiving portion 102, a specification data receiving portion 103, an organizational chart generation portion 104, a linking portion 105, an organizational chart storage portion 106, an organizational chart transmission portion 107, and so on, all of which are shown in FIG. 3.

The business card management program 21P implements, in the business card DB server 2B, the functions of a personal data storage portion 201, a personal data creation portion 202, a change data storage portion 203, a change data creation portion 204, an organization-related data transmission portion 205, and so on, all of which are shown in FIG. 4.

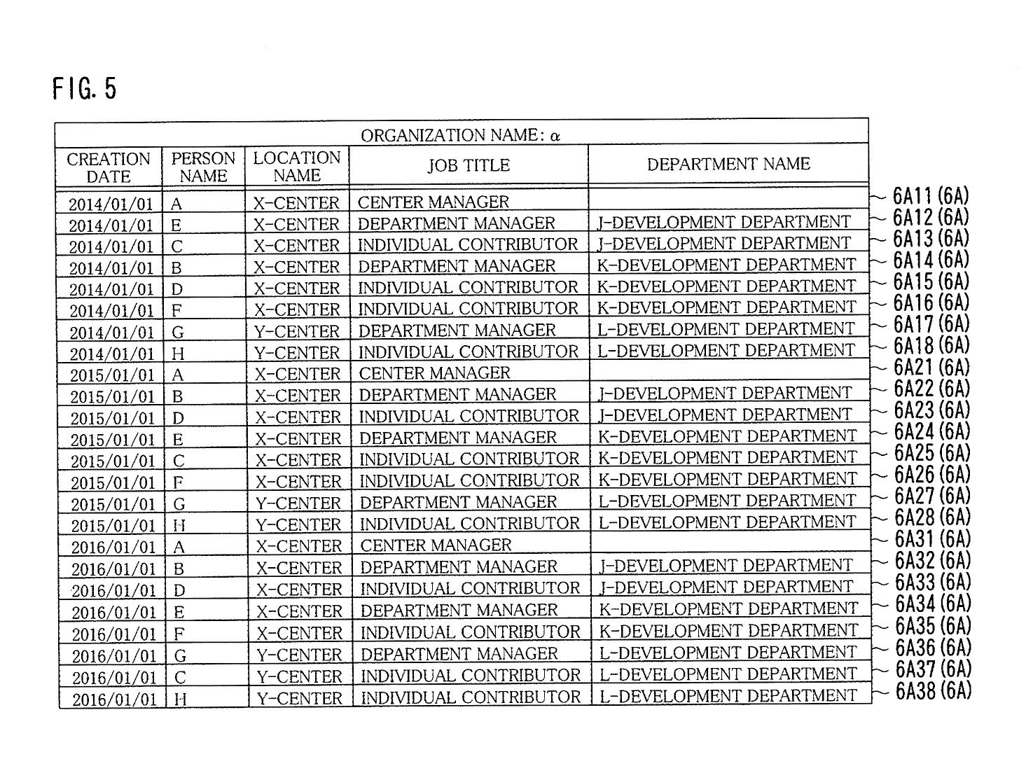

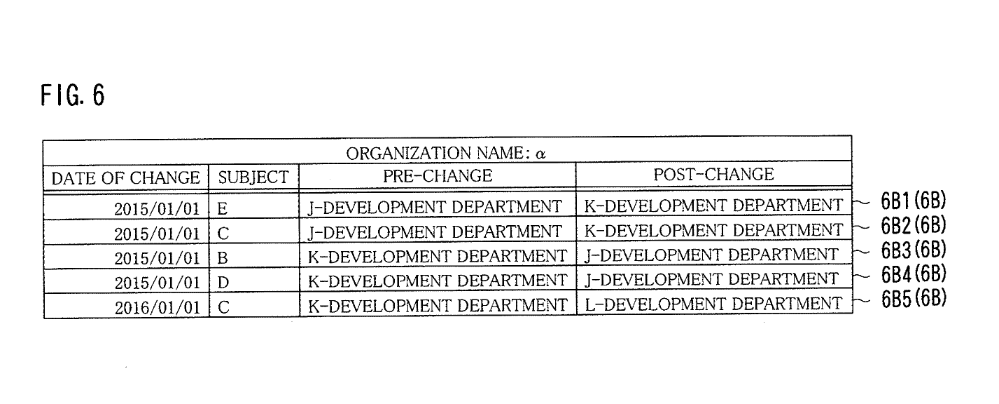

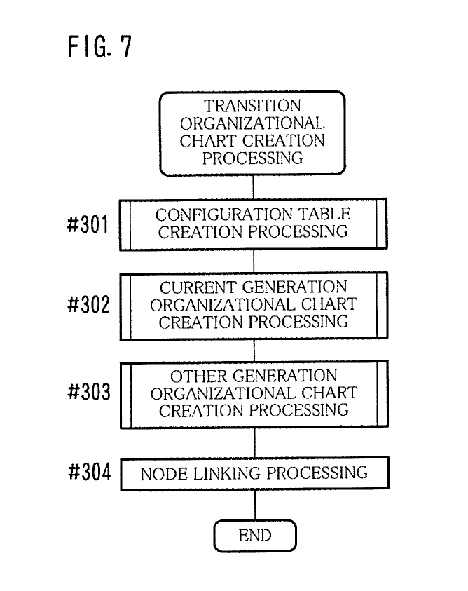

FIG. 5 is a diagram showing an example of the personal data 6A. FIG. 6 is a diagram showing an example of change data 6B. FIG. 7 is a flowchart depicting an example of the flow of transition organizational chart creation processing.

In the business card DB server 2B, the personal data storage portion 201 stores, therein, the sets of personal data 6A on persons who are in an organization, e.g., in a company, in such a manner that the sets of personal data 6A are classified in a table for each organization. For example, as shown in FIG. 5, sets of personal data 6A11-6A38 are stored, as the sets of personal data 6A, for each person working in the α-company, in a table for the α-company.

The personal data 6A indicates the information as discussed below related to the corresponding person. The “creation date” is a date at which the corresponding personal data 6A is created.

The “person name” is the name of the corresponding person. The “organization name” is the name of an organization where the corresponding person is in. The “location name” is the name of a business site where the corresponding person works. The “job title” is the name of a job title given to the corresponding person. The “department name” is the name of a department where the corresponding person is in. It is noted that no department name is applied to a person who takes a position of generally managing all the departments of one business site (center manager in this example).

The personal data 6A is generated by the personal data creation portion 202 and is stored into the personal data storage portion 201, for example, in the following manner.

The business card DB server 2B receives an input of image data obtained by taking a picture of a business card or scanning the business card.

The personal data creation portion 202 performs Optical Character Recognition (OCR) processing on the image data to extract, from the image data, the name of a person, organization name, location name, department name, and job title.

The personal data creation portion 202 then generates data that indicates the current date as a creation date and shows the information extracted. The personal data creation portion 202 then stores, as the personal data 6A, the data generated into a table corresponding to the organization of the personal data storage portion 201.

In some cases, image data on a business card of a certain person is sent to the business card DB server 2B a plurality of times. Even in such a case, every time the image data is sent thereto, the personal data storage portion 201 performs the processing for generating personal data 6A to store the same. Thus, a plurality of sets of the personal data 6A on one person are stored in the personal data storage portion 201 in some cases.

The change data storage portion 203 stores, therein, the change data 6B for each change in person or in department so that the change data 6B is classified into an organization-specific table.

Referring to FIG. 6, for example, the change data 6B for each change in person or in department of the α-company is stored in a table for the α-company. The following is a description of an example in which the change is a personnel change (personnel shift). Another example of the change is described later.

The change data 6B indicates information related to the change, for example, indicates the following information. In the field of “date of change”, a date at which the corresponding change has been detected is indicated. In the field of “subject”, a subject to which the change has been made is indicated. In short, in this example, the subject indicates the name of a person to whom the personnel change has been made.

In the fields of “pre-change” and “post-change”, a state of the subject before the change and a state of the subject after the change are indicated, respectively. In short, in this example, a department name of the corresponding person before the personnel change and a department name of the corresponding person after the personnel change are indicated, respectively.

When the personal data creation portion 202 generates new personal data 6A, the change data creation portion 204 generates change data 6B to store the change data 6B into the change data storage portion 203 in the following manner.

The change data creation portion 204 searches, in the personal data storage portion 201, for personal data 6A having the same person name as that of the personal data 6A newly generated by the personal data creation portion 202. The change data creation portion 204 then compares the department names of the two sets of personal data 6A, namely, the new personal data 6A and the personal data 6A found out by the search. If the two sets of personal data 6A are different from each other, namely, if a personnel change is made probably, then the change data creation portion 204 generates a new set of change data 6B. The change data 6B indicates, in the “date of change”, a date at which the new personal data 6A has been generated. The change data 6B indicates, in the “subject”, the person name in the personal data 6A found out by the search. The change data 6B indicates, in the “pre-change”, the department name in the personal data 6A found out by the search. The change data 6B indicates, in the “post-change”, a department name of the new personal data 6A.

It is also possible that an operator operates the business card DB server 2B to enter the pieces of information and generates change data 6B based on the information entered.

The user in the β-company operates his/her terminal 3 to make a web browser thereof access a predetermined web page of the organizational chart creation server 2A. The user then determines for which organization an organizational chart 7B is to be generated. In this example, the user designates the α-company. The user also designates a target and a source of the organization (namely, the α-company).

The “target” is an employee that the user wishes to contact among employees of the α-company. The “source” is an employee that the user can contact directly, for example, an employee with whom the user previously exchanged business cards, among the employees of the α-company.

In response to the organization, target, and source designated, the web browser of the terminal 3 sends specification data 6C indicating the organization, target, and source to the organizational chart creation server 2A.

With the organizational chart creation server 2A, the specification data receiving portion 103 receives the specification data 6C from the terminal 3.

In response to the receipt, the organization-related data receiving portion 102 receives, from the business card DB server 2B, the personal data 6A on persons of the organization indicated in the specification data 6C and the change data 6B on that organization in the following manner.

The organization-related data receiving portion 102 accesses the business card DB server 2B to send request data 6D to the same. The request data 6D shows the organization indicated in the specification data 6C. In this example, the α-company is indicated in the request data 6D.

With the business card DB server 2B, the organization-related data transmission portion 205 receives the request data 6D. In response thereto, the organization-related data transmission portion 205 sends the personal data 6A and the change data 6B to the organizational chart creation server 2A as follows.

The organization-related data transmission portion 205 retrieves the personal data 6A on persons of the organization indicated in the request data 6D and the change data 6B on that organization from the personal data storage portion 201 and the change data storage portion 203, respectively. The organization-related data transmission portion 205 then sends the data thus retrieved to the organizational chart creation server 2A.

With the organizational chart creation server 2A, the organization-related data receiving portion 102 receives the personal data 6A and the change data 6B.

The personal data 6A and the change data 6B thus received are stored into the organization-related data storage portion 101. If the personal data storage portion 201 of the business card DB server 2B stores the personal data 6A11-6A38 shown in FIG. 5 as the personal data 6A on persons of the α-company, then the personal data 6A11-6A38 is stored also into the organization-related data storage portion 101. Further, if the change data storage portion 203 of the business card DB server 2B stores change data 6B1-6B5 shown in FIG. 6 as the change data 6B for the α-company, then the change data 6B1-6B5 is stored also into the organization-related data storage portion 101.

The organizational chart generation portion 104 and the linking portion 105 generate a transition organizational chart 7B based on the personal data 6A and the change data 6B. The processing thereof is executed in the steps as depicted in FIG. 7.

The organizational chart generation portion 104 generates a table that indicates a structure of persons of the α-company per predetermined period of time (Step #301 of FIG. 7). The organizational chart generation portion 104 generates an organizational chart 7A for the latest predetermined period of time based on a table for that period of time (Step #302). The organizational chart generation portion 104 generates an organizational chart 7A for each of other predetermined periods of time based on the individual tables (Step #303). The linking portion 105 generates a transition organizational chart 7B by linking, with a line or a ribbon, person names of a person who appears in both of two adjacent predetermined periods of time (Step #304). The description goes on to the detailed processing of each step.

[Creation of Configuration Table 6E (Processing of Step #301)]

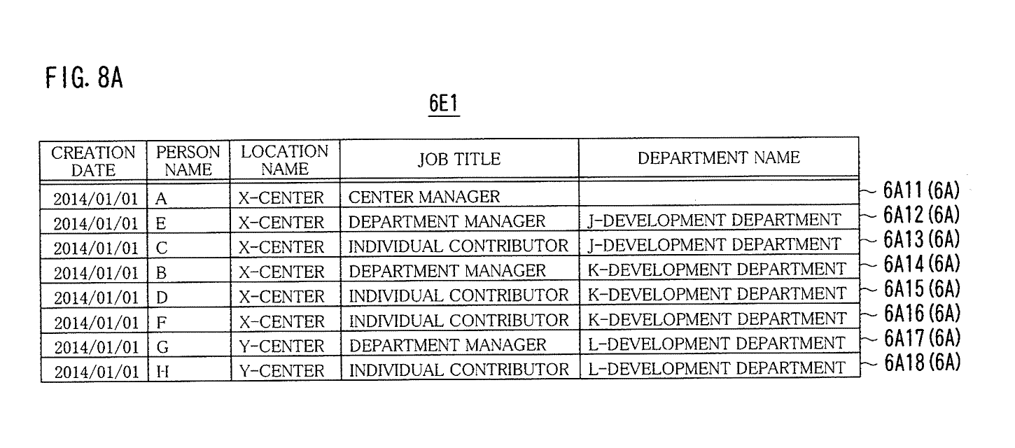

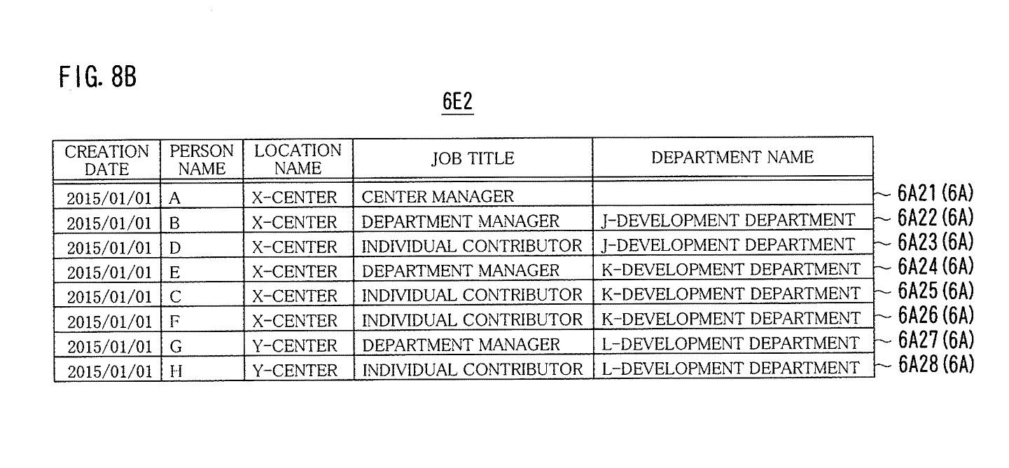

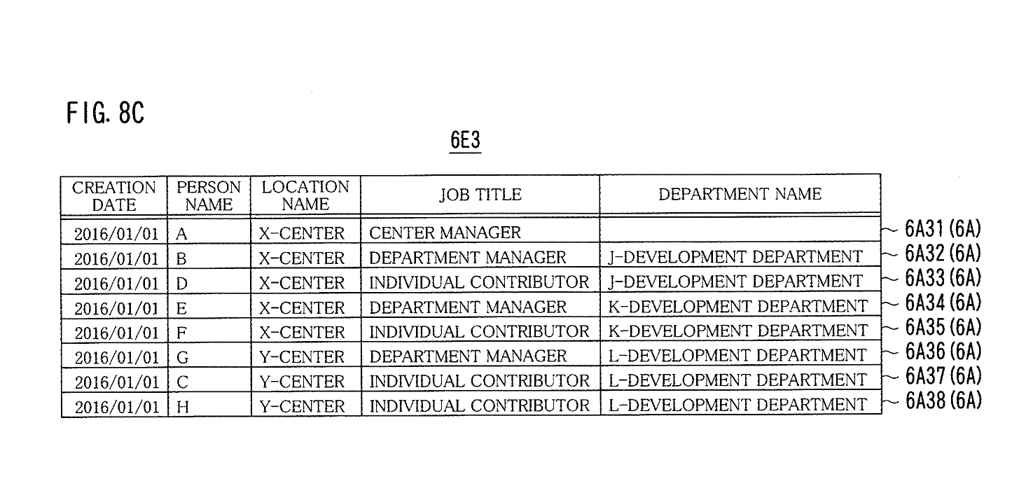

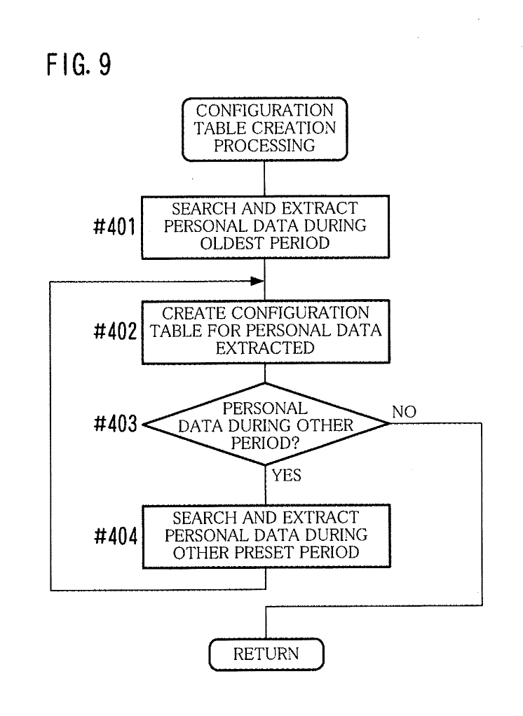

FIGS. 8A-8C are diagrams showing examples of a configuration table 6E. FIG. 9 is a flowchart depicting an example of the flow of configuration table creation processing.

The organizational chart generation portion 104 generates one configuration table 6E per predetermined period of time as shown in FIGS. 8A-8C. The following description takes an example of a case where the predetermined period of time corresponds to a period between January 1^{St} and December 31^{st} every year. The period is set in line with an organizational change in the α-company which is made on January 1^{st}. The predetermined period of time may be designated by the user.

The organizational chart generation portion 104 creates a configuration table 6E1 as the configuration table 6E for a predetermined period of time which is older than any other predetermined periods of time. The steps for creating the configuration table 6E1 are depicted in FIG. 9.

The organizational chart generation portion 104 extracts, from the organization-related data storage portion 101, personal data 6A on persons who worked in the α-company during a period (year) including the oldest creation date among creation dates indicated in the sets of personal data 6A stored in the organization-related data storage portion 101 (Step #401 of FIG. 9). In short, the organizational chart generation portion 104 extracts personal data 6A of which a creation date falls within the period.

Where the personal data 6A stored in the organization-related data storage portion 101 is the same as that shown in FIG. 5, the organizational chart generation portion 104 extracts, as the personal data 6A for a period between Jan. 1, 2014 and Dec. 31, 2014, the personal data 6A11, 6A12, 6A13, 6A14, 6A15, 6A16, 6A17, and 6A18 for persons named “A”, “E”, “C”, “B”, “D”, “F”, “G”, and “H”, respectively.

However, as for a person, if there are a plurality of sets of personal data 6A having a creation date falling within the period, it is preferably to extract only a set of the personal data 6A indicating the latest creation date as compared to the other sets of the personal data 6A. The same is similarly applied to the description discussed below.

The organizational chart generation portion 104 then creates a configuration table 6E1 by combining the sets of personal data 6A extracted as shown in FIG. 8A (Step #402).

The organizational chart generation portion 104 then creates a configuration table 6E (configuration table 6E2) for the next period by extracting a plurality of sets of personal data 6A of which a creation date falls within the next period and combining the extracted sets of personal data 6A (YES in Step #403, Step #404 and Step #402).

Thereby, in this example, a plurality of sets of personal data 6A21, 6A22, 6A23, 6A24, 6A25, 6A26, 6A27, and 6A28 for persons named “A”, “B”, “D”, “E”, “C”, “F”, “G”, and “H”, respectively are extracted as the personal data 6A for a period between Jan. 1, 2015 to Dec. 31, 2015, so that the configuration table 6E2 as shown in FIG. 8B is created.

In a similar fashion, the organizational chart generation portion 104 creates a configuration table 6E for each of the other predetermined periods of time by extracting sets of personal data 6A for that corresponding period from the organization-related data storage portion 101 and combining the extracted sets of personal data 6A (YES in Step #403, Step #404, Step #402).

The foregoing processing is performed, so that in this example the three configuration tables 6E1-6E3 shown in FIGS. 8A-8C are created as the configuration table 6E. Hereinafter, the periods are referred to as a “first generation”, a “second generation”, . . . , and so on in chronological order. The latest period is referred to as a “current generation”. The current generation is a third generation in this example. Each of the configuration tables 6E is set to correspond to a generation name. To be specific, the configuration tables 6E1, 6E2, and 6E3 are set to correspond to the “first generation”, the “second generation”, and “third generation”, respectively in this example.

[Structure of Organizational Chart 7A]

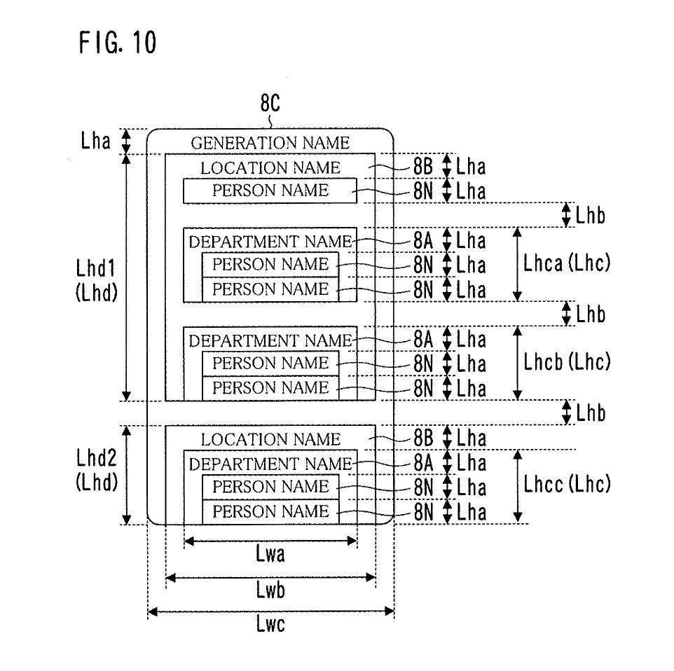

FIG. 10 shows an example of a format of the organizational chart 7A.

In the meantime, the organizational chart 7A has three areas of a first area 8A, a second area 8B, and a third area 8C as shown in FIG. 10.

In the third area 8C, an image showing the entirety of the organization in a generation is provided. The third area 8C contains a second area 8B for each business site of the organization in the corresponding generation. The third area 8C also has a generation name for the corresponding generation (“first generation”, “second generation”, or the like for example).

In the second area 8B, an image showing the entirety of the business site is provided. The second area 8B has a location name of the business site and contains a first area 8A for each department of the business site. If someone has a job title of supervisor who has control over all the departments of the business site (hereinafter referred to as a “business site supervisor”), an image of a node representing that person is provided. Hereinafter, such an image of a node is referred to as a “node image 8N”. The node image 8N includes a person name and a frame. The node image 8N sometimes includes a job title. The node image 8N includes no job title where the job title is an “individual contributor”. The node image 8N includes a job title where the job title is something other than the “individual contributor”.

In the first area 8A, an image showing a department is provided. The first area 8A has a department name of the department and contains a node image 8N for each person who works in the department.

The heights of the generation name, the location name, the department name, and the node image 8N are constant. Each of the heights is a height Lha. Two second areas 8B adjacent to each other have a gap distance therebetween. The gap distance is a distance Lhb. Similarly, as to a certain business site, two first areas 8A adjacent to each other in the second area 8B have a gap distance of the distance Lhb therebetween. If someone works as a business site supervisor in the business site, the node image 8N for the business site supervisor and the top first area 8A have a gap distance Lhb therebetween.

[Creation of Current Generation Organizational Chart 7A (Processing of Step #302)]

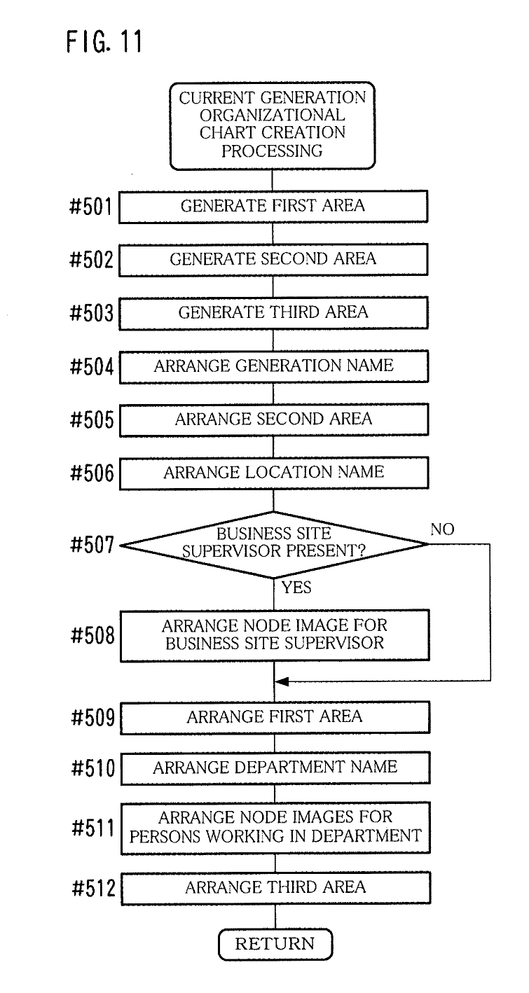

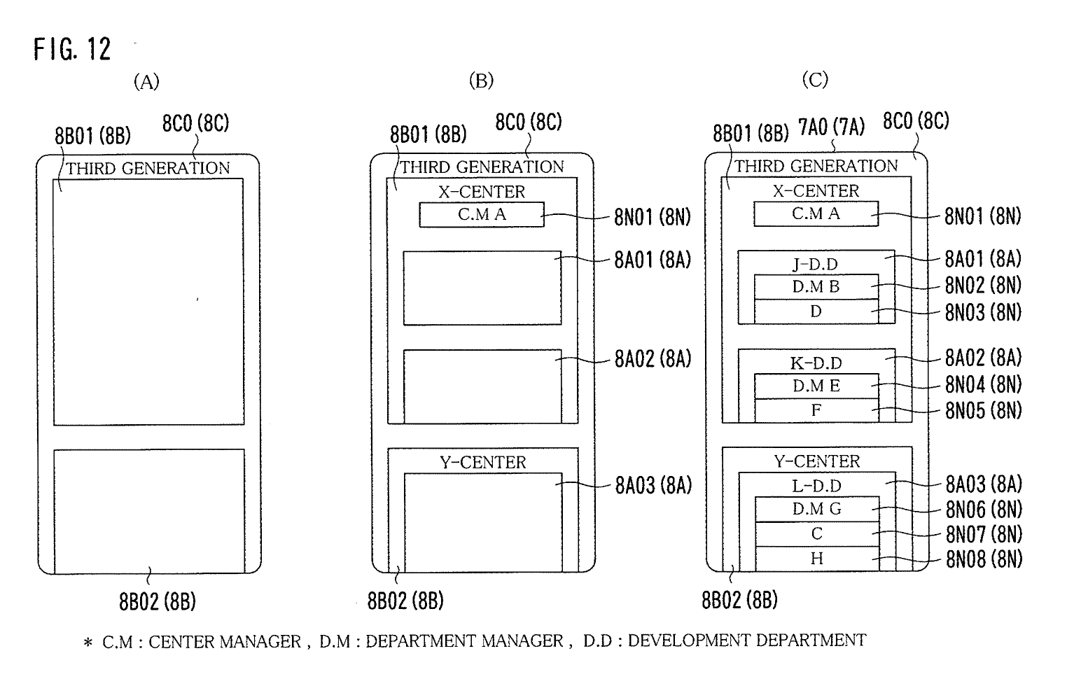

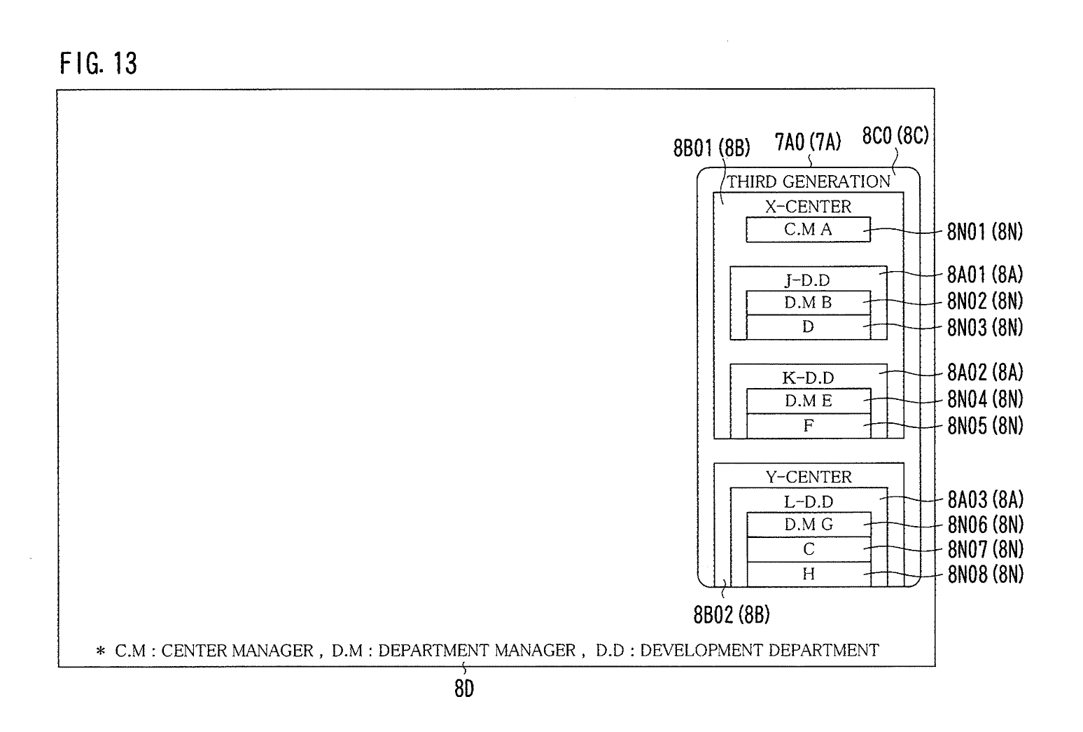

FIG. 11 is a flowchart depicting an example of the flow of current generation organizational chart creation processing. FIG. 12 is a diagram showing an example of the course of creation of the current generation organizational chart 7A. FIG. 13 is a diagram showing an example as to how to put the current generation organizational chart 7A in an entire area 8D.

The organizational chart generation portion 104 creates, as the current generation organizational chart 7A, a current organizational chart 7A0 based on the current generation configuration table 6E (configuration table 6E3 shown in FIG. 8C in this example) in the steps as depicted in FIG. 11.

The organizational chart generation portion 104 generates a first area 8A for each department name indicated in any set of the personal data 6A of the configuration table 6E3, namely, for each department (Step #501). The department name is set to correspond to the first area 8A.

The first area 8A has a height Lhc which is calculated by Lha×(Na+1). Herein, “Na” represents the number of sets of personal data 6A indicating the department name of the first area 8A. The numeral “1” of “Na+1” corresponds to a height of the department name. Hereinafter, the height Lhc of the top first area 8A, the height Lhc of the second top first area 8A, . . . , and so on are sometimes distinguished from one another as a “height Lhca”, a “height Lhcb”, . . . , and so on.

The first area 8A has a width Lwa within which a character string having the longest length among a character string of a department name of a department corresponding to the first area 8A and a combined character string of a job title and a person name of each person who works in the department. In order to ensure that all the character strings are enough to fit within the width Lwa of the first area 8A, the length may be a length corresponding to the longest character string plus a few characters (two characters, for example). For example, where the character width per character is denoted by Lwt and the longest character string is the length corresponding to ten characters, the width Lwa is obtained by the calculation of Lwt×(10+2).

It is also possible that all the first areas 8A have the same width Lwa as one another. In such a case, the width Lwa may be determined based on the longest character string of the character strings in the current generation by the foregoing method. The description goes on to a case of using this method.

The organizational chart generation portion 104 creates a second area 8B (Step #502) for each location name indicated in any set of the personal data 6A of the configuration table 6E3, namely, for each business site. The location name is set to correspond to the second area 8B.

The height Lhd of the second area 8B is obtained by the calculation of SUM(Lhc)+Lhb×(Nb−1)+Lha×2+Lhb for the case where someone works as a business site supervisor in a business site corresponding to the second area 8B. In the expression, “SUM(Lhc)” represents the sum of the heights Lhc of the first areas 8A to be arranged in the second area 8B, and “Nb” represents the number of first areas 8A. The second term represents the total sum of distances between the respective two adjacent first areas 8A. The third term represents the total sum of the height of the node image 8N for the business site supervisor and the height of the location name. The fourth term represents a distance between the node image 8N for the business site supervisor and the top first area 8A.

In this example, a second area 8B01 that is the second area 8B for the X-center corresponds to this case. Since Nb=2, the height Lhd of the second area 8B01 (hereinafter referred to as a “height Lhd1”), is obtained by the calculation of the expression of (Lhca+Lhcb)+Lhb+Lha×2+Lhb.

On the other hand, if nobody has a position of business site supervisor, then the height Lhd is obtained by the calculation of the expression of SUM(Lhc)+Lhb(Nb−1)+Lha.

In this example, a second area 8B02 that is the second area 8B for a Y-center corresponds to this case. Since Nb=1, the height Lhd of the second area 8B02 (herein after referred to as a “height Lhd2”), is obtained by the calculation of Lhcc+Lha.

The width Lwb of the second area 8B is obtained by adding a predetermined length (width of two characters, for example) to the width Lwa.

The organizational chart generation portion 104 then creates, as the third area 8C for the current generation, a third area 8C0 (Step #503).

The height of the third area 8C0 is obtained by the calculation of SUM(Lhd)+Lhb(Nc−1)+Lha. In the expression, “SUM(Lhd)” represents the sum of the heights Lhd of the second areas 8B to be arranged in the third area 8C0. In this example, the SUM(Lhd) is obtained by the calculation of Lhd1+Lhd2. In the expression, “Nc” represents the number of second areas 8B. The second term represents the total sum of distances between the two adjacent second areas 8B. The third term represents a height of the generation name.

The width Lwc of the third area 8C is obtained by adding a predetermined length (width of two characters, for example) to the width Lwb.

The organizational chart generation portion 104 creates the first area 8A, the second area 8B, and the third area 8C for the current generation as described above. The organizational chart generation portion 104 then combines the areas, the generation name, the location name, the department names, and the node images 8N in the following manner.

The organizational chart generation portion 104 adds a generation name of the current generation to the upper end of the third area 8C (Step #504). The generation name is the one associated with the configuration table 6E3. The organizational chart generation portion 104 then adds, under the generation name, the second areas 8B in accordance with a predetermined order (in alphabetical order or in numerical order, for example) (Step #505). It is, however, noted that no space is left between the generation name and the top second area 8B. The adjacent second areas 8B are spaced from each other by a distance Lhb.

The foregoing processing is performed, so that the generation name of “third generation”, the third area 8C0, and the second areas 8B01 and 8B02 are arranged as shown in (A) of FIG. 12.

The organizational chart generation portion 104 then adds, to the upper end of each of the second areas 8B, a location name corresponding to each of the second areas 8B (Step #506).

If someone works as a business site supervisor in the business site corresponding to the location name (YES in Step #507), then the organizational chart generation portion 104 adds a node image 8N for the business site supervisor under the location name (Step #508). The node image 8N has a frame surrounding a person name and a job title of the business site supervisor. The organizational chart generation portion 104 adds, under the node image 8N, the first areas 8A of the departments of the business site in the foregoing predetermined order (Step #509). It is, however, noted that no space is left between the location name and the node image 8N. The node image 8N and the top first area 8A are spaced from each other by a distance Lhb. The adjacent first areas 8A are spaced from each other by a distance Lhb.

Where the configuration table 6E3 stores, therein, personal data 6A indicating the location name and the job title (“center manager” in this example), it means that somebody works as the business site supervisor. The person name indicated in the personal data 6A is the person name of the business site supervisor.

If nobody works as the business site supervisor in the business site corresponding to the location name (NO in Step #507), then the organizational chart generation portion 104 adds, under the location name, the first areas 8A of the departments in the business site in accordance with the predetermined order (Step #509). It is, however, noted that no space is left between the location name and the top first area 8A. The adjacent first areas 8A are spaced from each other by a distance Lhb.

The foregoing processing is performed, so that the location name of “X-center” is added to the second area 8B01, the first areas 8A01 and 8A02 are placed, and a node image 8N01 is added as the node image 8N, and the location name of “Y-center”, and the first area 8A03 are added to the second area 8B02 as shown in (B) of FIG. 12.

The organizational chart generation portion 104 further adds, to the upper end of each of the first areas 8A, a department name corresponding to the first area 8A (Step #510). The organizational chart generation portion 104 then arranges the node images 8N for persons who work in a department corresponding to the department name in accordance with the predetermined of job titles (Step #511).

Where persons having the same job title as each other are shown in the first area 8A, the node images 8N for the persons are arranged in accordance with the foregoing predetermined order. No space is left between the department name and the top node image 8N. No space is left between the adjacent node images 8N.

The person names and the job titles of the individual persons are indicated in the sets of personal data 6A having the department name stored in the configuration table 6E3.

The foregoing processing is performed, so that the department names are arranged in the first areas 8A01, 8A02, and 8A03, and node images 8N02-8N08 are arranged as the node images 8N as shown in (C) of FIG. 12.

The organizational chart generation portion 104 arranges the second areas 8B, the first areas 8A, the location names, the department names, and the node images 8N in the third area 8C. After that, the organizational chart generation portion 104 arranges the third area 8C in the right end of the entire area 8D as shown in FIG. 13 (Step #512). The entire area 8D is a rectangular region in which the entirety of the transition organizational chart 7B is provided. The original is the apex on the lower left, the Y-axis is along the left side, and the X-axis is along the lower side.

[Creation of Organizational Chart 7A for Generation Other than Current Generation (Processing of Step #303)]

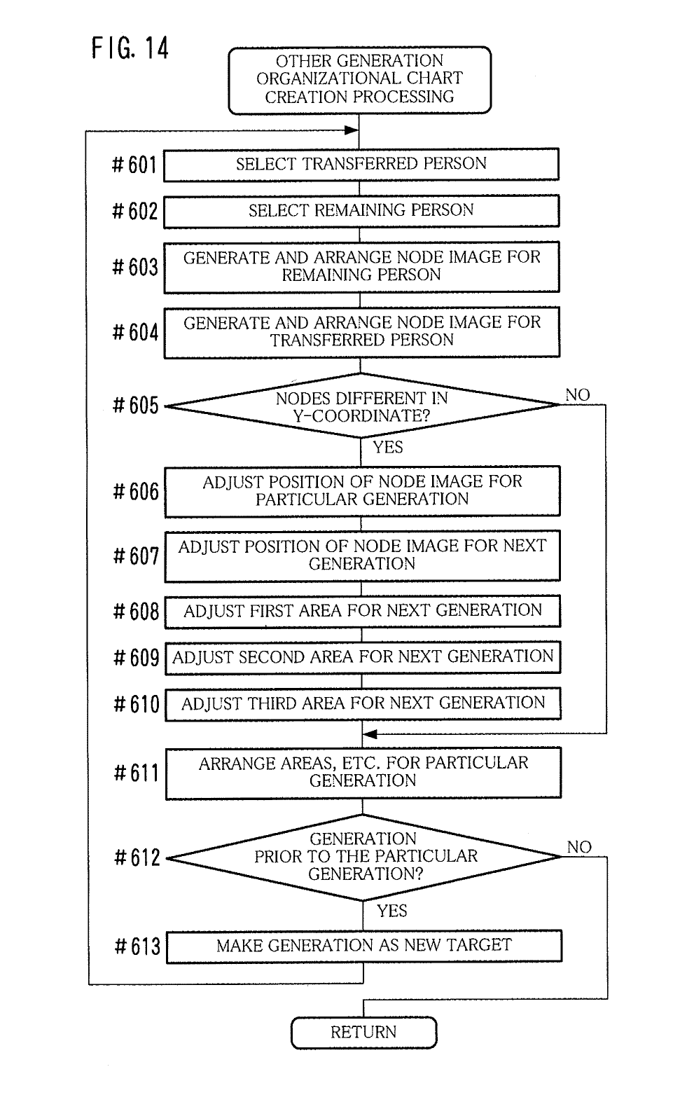

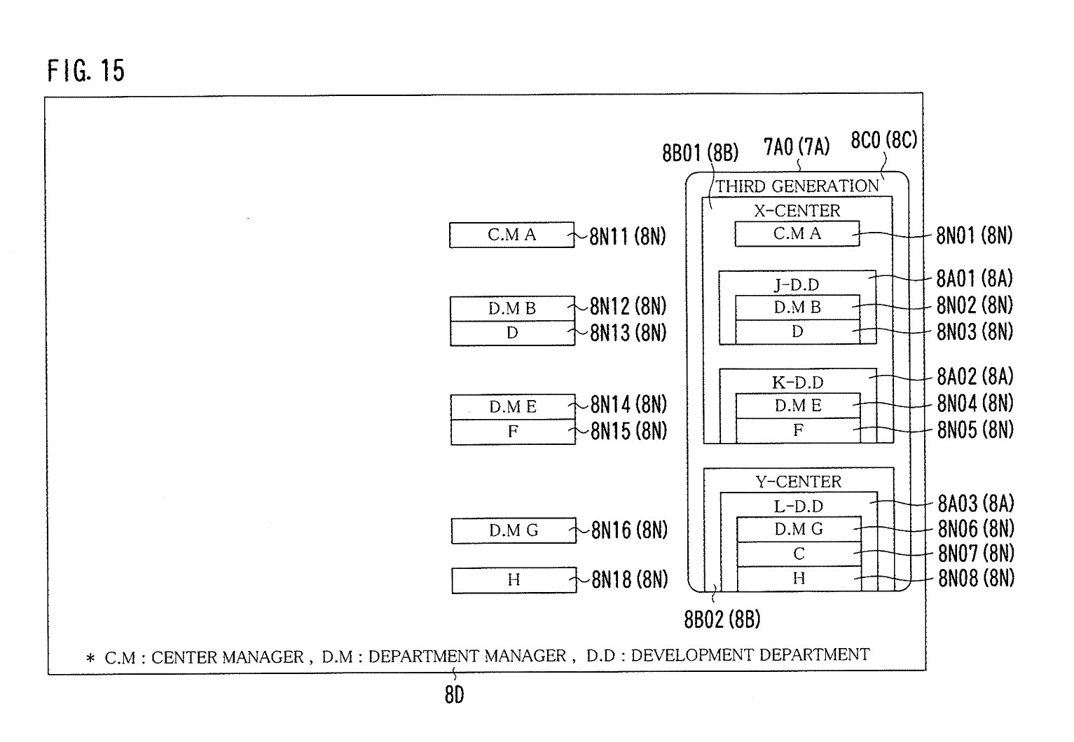

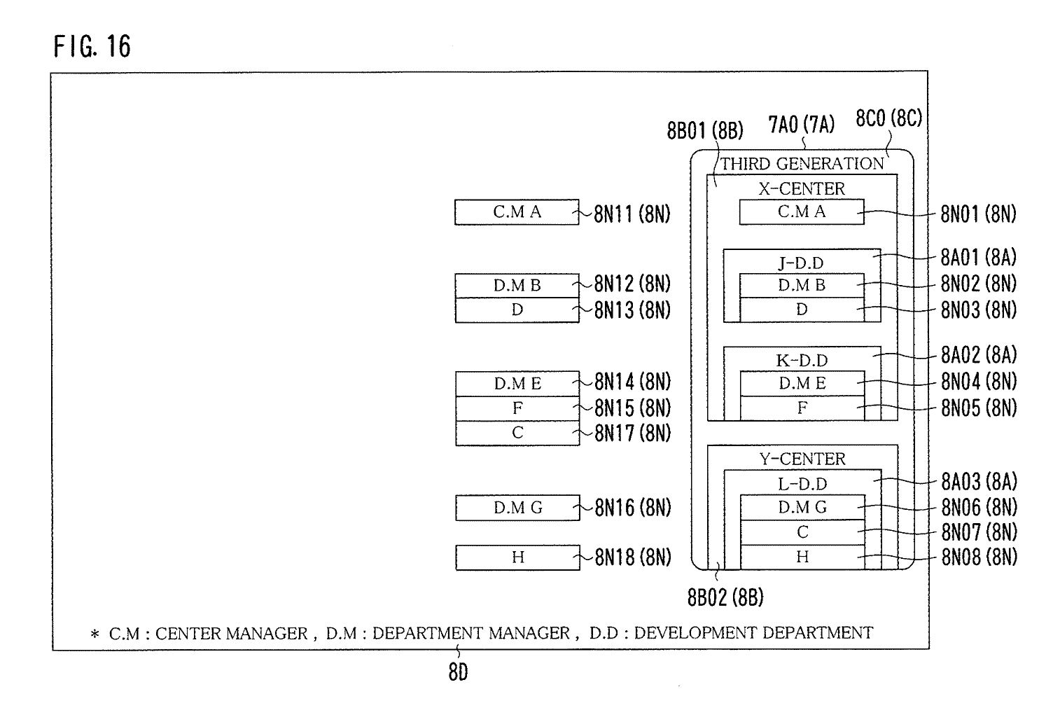

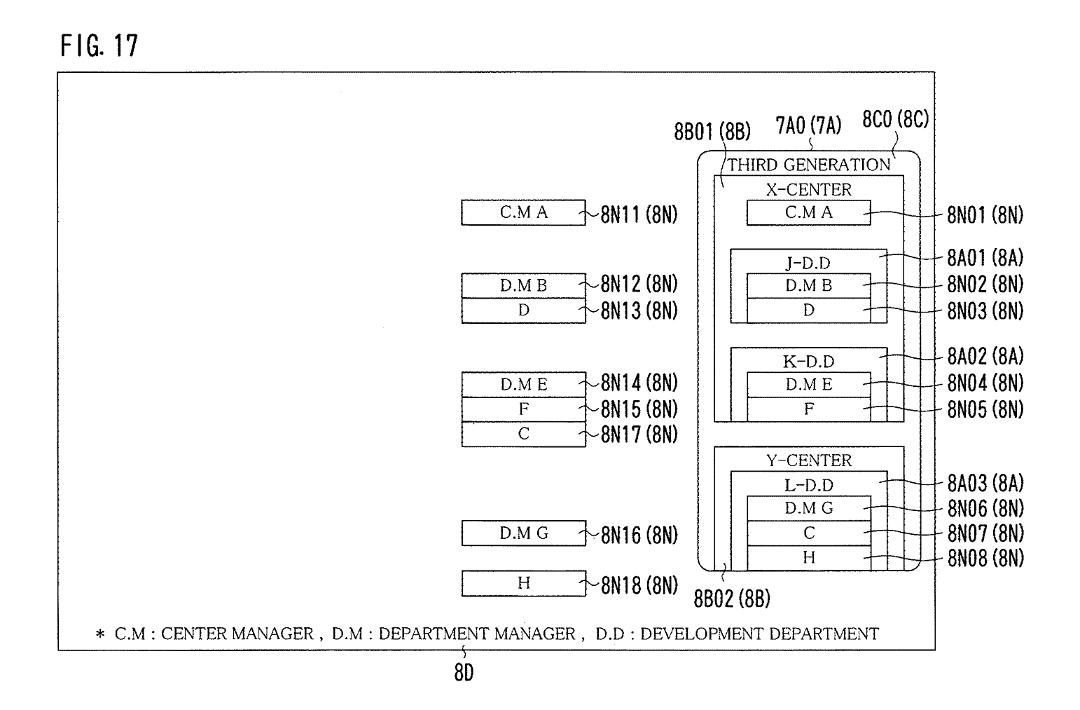

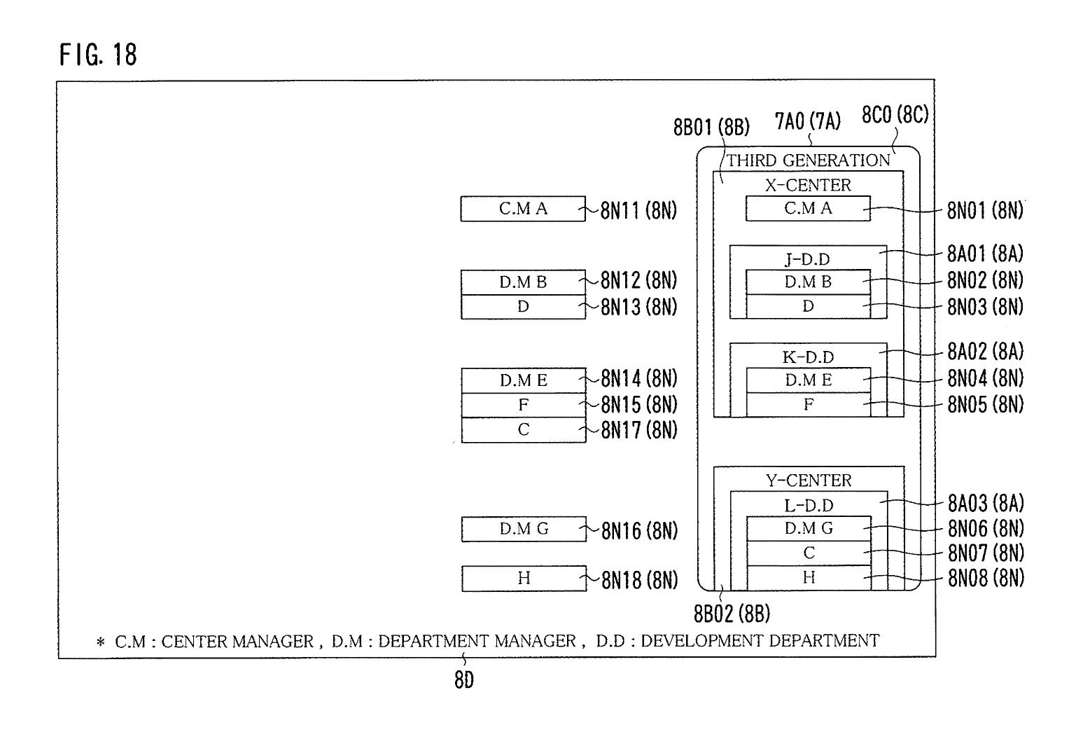

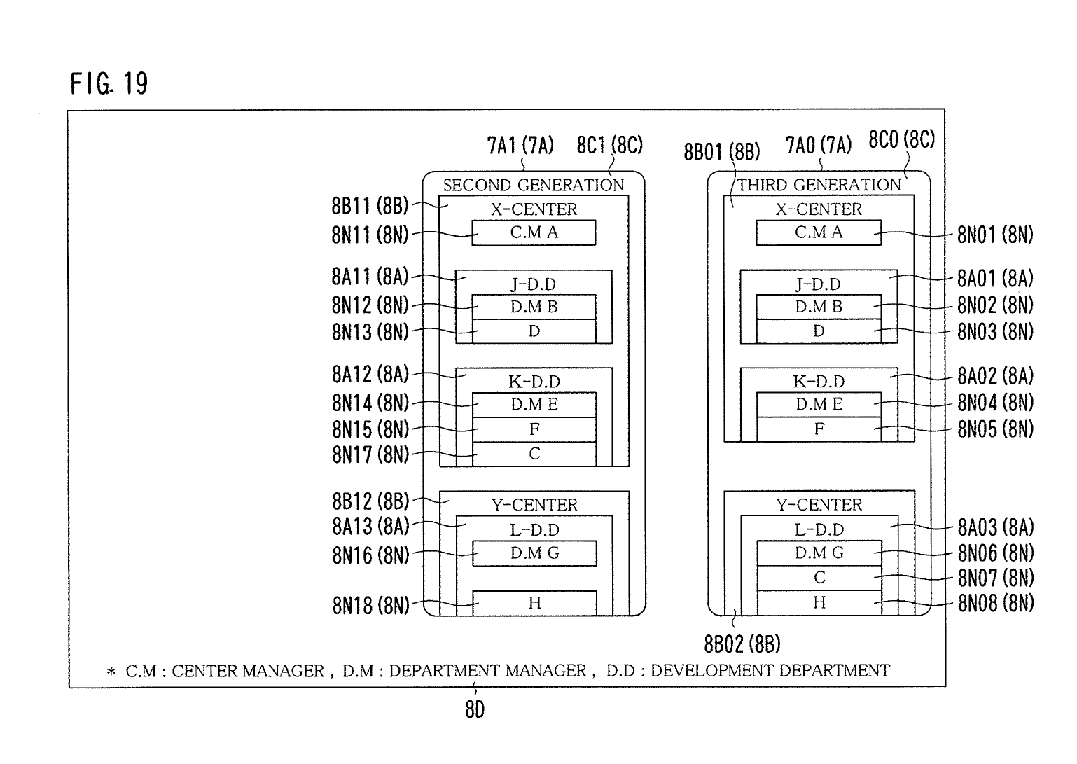

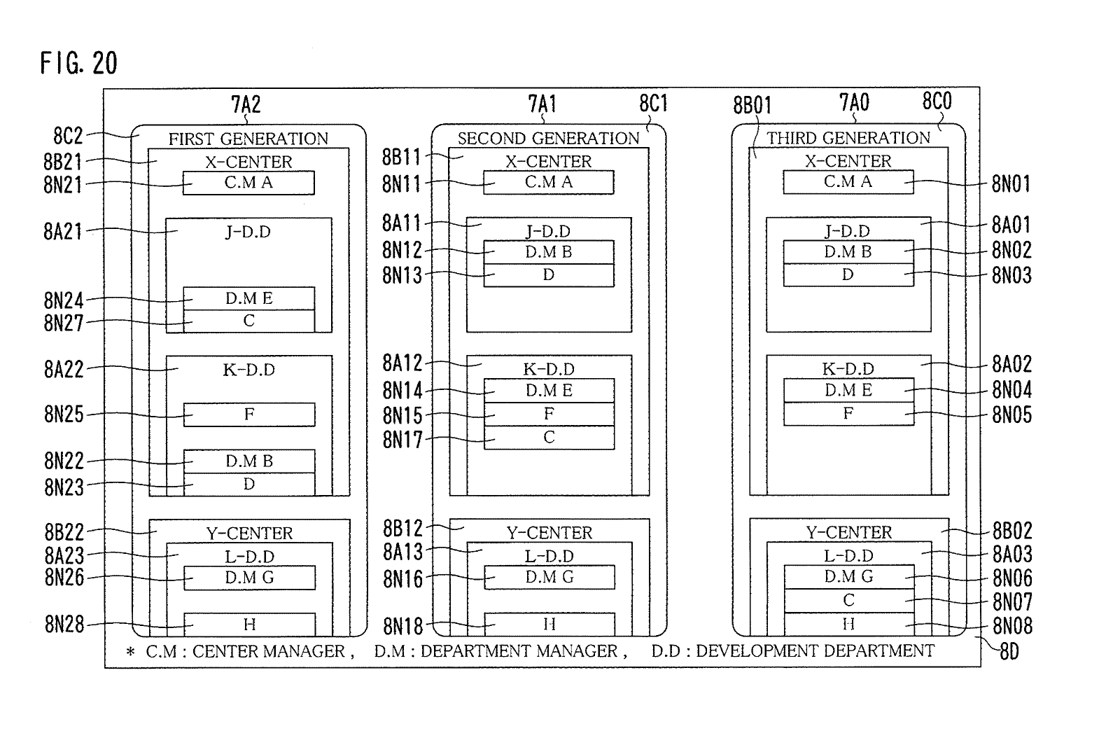

FIG. 14 is a flowchart depicting an example of the flow of other generation organizational chart creation processing. FIG. 15 is a diagram showing an example as to how to put a node image 8N for a remaining person in the entire area 8D. FIG. 16 is a diagram showing an example as to how to put a node image 8N for a transferred person in the entire area 8D. FIG. 17 is a diagram showing an example as to how to adjust positions of node images of a particular generation. FIG. 18 is a diagram showing an example as to how to adjust positions of the node images 8N of the next generation. FIG. 19 is a diagram showing an example as to how to put the first area 8A, the second area 8B, and the third area 8C of a particular generation in the entire area 8D. FIG. 20 is a diagram showing an example as to how to put an organizational chart 7A2 in the entire area 8D.

The organizational chart generation portion 104 creates, in the entire area 8D, the organizational charts 7A for generations other than the current generation in order from newest generation to oldest generation as depicted in the steps of FIG. 14.

The organizational chart generation portion 104 makes a generation immediately preceding the current generation as a target generation. Hereinafter, a generation made as the target generation is referred to as a “particular generation”. A generation immediately after the particular generation is referred to as a “next generation”. The organizational chart generation portion 104 then creates an organizational chart 7A for the particular generation based on the change data 6B (see FIG. 6) and the configuration table 6E (see FIGS. 8A-8C) for the particular generation in the following manner.

The organizational chart generation portion 104 selects, from among the node images 8N of the organizational chart 7A for the next generation, a node image 8N for a person having a department name different between the particular generation and the next generation (Step #601). In short, the organizational chart generation portion 104 selects a person who has transferred to another department between both the generations. Hereinafter, such a person is referred to as a “transferred person”.

Such a transferred person can be identified by searching for change data 6B of which a date of change falls within the next generation. The change data 6B indicates a person name. A person corresponding to the person name is a “transferred person”. The organizational chart generation portion 104 further selects a person other than the transferred person, namely, a person who has not been subjected to the personnel transfer, as a remaining person (Step #602).

The organizational chart generation portion 104 generates a node image 8N for the person who has been selected as the remaining person, and places the node image 8N thus generated on the left of the node image 8N for the identical person in the organizational chart 7A for the next generation with a distance Lwd provided between the two node images 8N (Step #603). As discussed earlier, the node image 8N generated indicates a person name of the person. Where the person is given a job title other than the “individual contributor”, the node image 8N also indicates the job title. The same is similarly applied to the following description.

It is, however, necessary to keep an enough distance between the organizational chart 7A for the particular generation and the organizational chart 7A for the next generation in order to avoid an overlap between the two organizational charts 7A. For example, the distance Lwd preferably has a distance corresponding to a half or so of the width Lwc (width of the organizational chart 7A0).

The processing is performed as discussed above, so that node images 8N11-8N16, and 8N18 are placed as the node images 8N as shown in FIG. 15.

The organizational chart generation portion 104 further creates a node image 8N for the person selected as the transferred person and places the node image 8N based on change data 6B in the following manner (Step #604). The change data 6B indicates a date of change falling within the next generation and indicates a person name of the person as the target.

The organizational chart generation portion 104 places the node image 8N for the person selected as the transferred person in such a manner that the upper side of the node image 8N contacts an extension of the lower side of the first area 8A for the next generation corresponding to the department name indicated as “pre-change” in the change data 6B, and that the left side of the node image 8N contacts an extension of the left side of the node image 8N for the person selected as the remaining person.

According to the processing, a node image 8N17 is placed, as the node image 8N, directly below the node image 8N15 to contact the node image 8N15 as shown in FIG. 16.

Alternatively, the node image 8N for the person selected as the transferred person may be placed directly below the bottommost node image 8N for the next generation to contact the bottommost node image 8N among node images 8N for persons who are in a department corresponding to the department name indicated as “pre-change” in the change data 6B.

If there are persons selected as the transferred person, then the organizational chart generation portion 104 places the node image 8N for each of the persons in the foregoing manner.

The method for determining the size of the node images 8N11-8N18 is the same as that for determining the size of the node images 8N01-8N08 in Step #302.

The foregoing processing is performed, so that the node images 8N for remaining persons in the particular generation and the next generation are placed in the horizontal direction (in the X-axis direction). Stated differently, both the node images 8N are equal to each other in Y-coordinate. However, the node images 8N for transferred person are different from each other in Y-coordinate. If the processing described below is performed as-is, the two first areas 8A sometimes contact or overlap each other, or the two second areas 8B sometimes contact or overlap each other. To address this, if this is the case (YES in Step #605), the organizational chart generation portion 104 adjusts the positions of the node images 8N in the following manner (Step #606).

The organizational chart generation portion 104 selects a node image 8N for a transferred person in the particular generation. The organizational chart generation portion 104 then moves all the node images 8N in the particular generation which are placed below the selected node image 8N to a lower position by a distance corresponding to the height Lha with the X-coordinate remaining unchanged.

The processing is performed in this way, so that the node images 8N16 and 8N18 move downward, in this example, as shown in FIG. 17.

If there are node images 8N for the transferred person, then the organizational chart generation portion 104 selects the node images 8N, one by one, in order from the top, and performs the processing of moving the selected node images 8N as described above.

The processing is performed in this way, so that the node images 8N for the identical remaining person in the particular generation and the next generation are not placed side by side in the horizontal direction.

To address this, the organizational chart generation portion 104 moves the node image 8N for the next generation out of the two node images 8N (Step #607) to arrange the two node images 8N side by side in the horizontal direction. The organizational chart generation portion 104 adjusts the first areas 8A in the following manner (Step #608). Where the node image 8N for the next generation is placed in the first area 8A, the organizational chart generation portion 104 moves the first area 8A also by the same distance as that of the movement of the node image 8N. Where moving all the first areas 8A contained in the second area 8B, the organizational chart generation portion 104 moves the second area 8B also by the same distance as that of the movement of all the first areas 8A. Where moving only a part of the first areas 8A contained in the second area 8B, the organizational chart generation portion 104 moves the lower side of the second area 8B to the position of the lower side of the bottommost first area 8A contained in the second area 8B with the position of the upper side of the second area 8B remaining unchanged (Step #609). Stated differently, the organizational chart generation portion 104 increases the height of the second area 8B.

The organizational chart generation portion 104 further lowers the lower side of the third area 8C for the next generation to the position of the lower side of the bottommost second area 8B of the next generation with the position of the upper side of the third area 8C remaining unchanged (Step #610). Stated differently, the organizational chart generation portion 104 increases the height of the third area 8C.

The processing is performed in this way, so that, as shown in FIG. 18, the second area 8B02, the first area 8A03, and the node images 8N06-8N08 are moved, and the second area 8B02 and the third area 8C0 are raised in this example.

In parallel with the processing of moving the first area 8A in the next generation and so on, or before or after the same, the organizational chart generation portion 104 places the first area 8A, the second area 8B, and the third area 8C of the particular generation and so on in the entire area 8D in the following manner (Step #611).

The organizational chart generation portion 104 places a department name of a department in such a manner that the department name externally contacts the upper side of the top node image 8N among node images 8N for persons working in that department. The organizational chart generation portion 104 then places the first area 8A in the entire area 8D so that the first area 8A contains the department name and the node images 8N. The height of the first area 8A is so set just enough to contain the department name and the node images 8N. The width of the first area 8A is determined by the same method as the method for determining the width of the first area 8A for the current generation.

The organizational chart generation portion 104 further places a location name of a business site in such a manner that the location name externally contacts the upper side of the top first area 8A among first areas 8A for departments in that business site. If someone takes a role of the business site supervisor in the business site, then the organizational chart generation portion 104 places the location name of the business site so as to contact the upper side of the node image 8N for the business site supervisor. The organizational chart generation portion 104 then places the second area 8B in the entire area 8D so that the second area 8B contains the location name and the first areas 8A. The height of the second area 8B is so set just enough to contain the location name and the first areas 8A. The width of the second area 8B is determined by the same method as the method for determining the width of the second area 8B of the current generation.

The organizational chart generation portion 104 further places a generation name of a particular generation in such a manner that the generation name externally contacts the upper side of the top second area 8B among second areas 8B for business sites. The organizational chart generation portion 104 then places the third area 8C in the entire area 8D so that the third area 8C contains the generation name and the second areas 8B. The height of the third area 8C is so set just enough to contain the generation name and the second areas 8B. The width of the third area 8C is determined by the same method as the method for determining the width of the third area 8C of the current generation.

The processing is performed in this way, so that, as shown in FIG. 19, the first areas 8A11-8A13, the second areas 8B11-8B12, the third area 8C1, the department name, the location name, and the generation name are placed in this example.

The organizational chart generation portion 104 performs the foregoing processing to create an organizational chart 7A for the particular generation in the entire area 8D. In this example, an organizational chart 7A1 is generated as the organizational chart 7A for the second generation.

If there is a generation prior to the current particular generation (YES in Step #612), then the organizational chart generation portion 104 makes the generation as a new target (Step #613). In other words, the organizational chart generation portion 104 sets the generation as a new particular generation. In this example, the organizational chart generation portion 104 sets the first generation as the new particular generation. After that, the foregoing processing is performed to create an organizational chart 7A for the new particular generation in the entire area 8D.

The processing is so performed that, in this example, the organizational chart 7A2 is created as the organizational chart 7A for the first generation as shown in FIG. 20 in this example.

At this time, however, a part or the whole of the node images 8N of the next generation is sometimes lowered. To cope with this, the organizational chart generation portion 104 makes adjustments in such a manner that a node image 8N for a generation subsequent to the next generation corresponding to the lowered node image 8N is arranged horizontally with the lowered node image 8N. Further, the organizational chart generation portion 104 adjusts first areas 8A, second areas 8B, and third areas 8C for the generation subsequent to the next generation. The method for the adjustment is the same as that depicted in Steps #606-#610.

[Linking of Node Images 8N (Processing of Step #304)]

FIG. 21 is a diagram showing an example of a transition organizational chart 7B.

The linking portion 105 links, in two adjacent organizational charts 7A, node images 8N for a person found in both the adjacent organizational charts 7A to each other with a line or a ribbon. Such a line or a ribbon is hereinafter referred to as a “linking image 8L”. At this time, a node image 8N for a person indicated as the target and a node image 8N for a person indicated as the source in the specification data 6C are so linked as to be conspicuous. For example, the node images 8N for the target person are linked to each other with a red linking image 8L1, the node images 8N for the source person are linked to each other with a yellow linking image 8L2, and node images 8N for the other persons are linked to each other with a black linking image 8L3. The linking image 8L3 is thinner than the linking image 8L1 and the linking image 8L2.

The foregoing processing is performed so that the transition organizational chart 7B is completed. In this example, where the target is “B” and the source is “C”, the transition organizational chart 7B as shown in FIG. 21 is completed. The transition organizational chart 7B is set to correspond to the organization name of the organization, and is stored in the form of transition organizational chart data 6F in the organizational chart storage portion 106.

The organizational chart transmission portion 107 sends the transition organizational chart data 6F to the transmission source of the specification data 6C, namely, the terminal 3.

When receiving the transition organizational chart data 6F, the terminal 3 displays the transition organizational chart 7B based on the transition organizational chart data 6F.

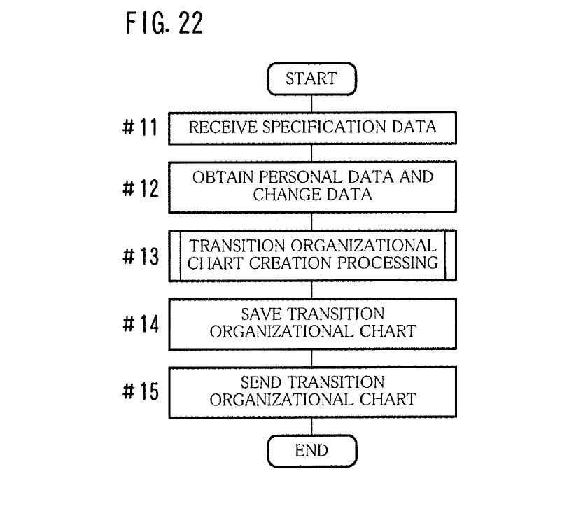

FIG. 22 is a flowchart depicting an example of the flow of the entire processing in the organizational chart creation server 2A.

The description goes on to the flow of the entire processing for creating the transition organizational chart 7B. The description is provided with reference to the flowchart.

The organizational chart creation server 2A performs processing in accordance with the transition organizational chart creation program 20P in the steps as depicted in FIG. 22.

The user uses the terminal 3 to select an organization, a target, and a source. In response to the selection, the terminal 3 sends specification data 6C to the organizational chart creation server 2A.

The organizational chart creation server 2A receives the specification data 6C from the terminal 3 (Step #11 of FIG. 22). The organizational chart creation server 2A sends request data 6D to the business card DB server 2B to obtain personal data 6A and change data 6B corresponding to the selected organization (Step #12).

The organizational chart creation server 2A creates the transition organizational chart 7B based on the personal data 6A and the change data 6B (Step #13). The steps for creating is the same as that described earlier with reference to FIG. 7.

After creating the transition organizational chart 7B, the organizational chart creation server 2A saves the transition organizational chart data 6F on the transition organizational chart 7B (Step #14), and sends the transition organizational chart data 6F to the terminal 3 (Step #15). The terminal 3 displays the transition organizational chart 7B based on the transition organizational chart data 6F.

In this embodiment, the organizational chart creation server 2A uses the linking images 8L to connect the node images 8N, for each generation, for persons working in an organization. In particular, as for a target person and a source person, the linking images 8L are reproduced in a form different from that for the other persons. In this embodiment, therefore, the user can find a way how to contact a person who is the target through a person who is the source more easily than is conventionally possible. In essence, the user uses an organizational chart obtained in this embodiment to find a method for contacting someone more easily than with the conventional methods

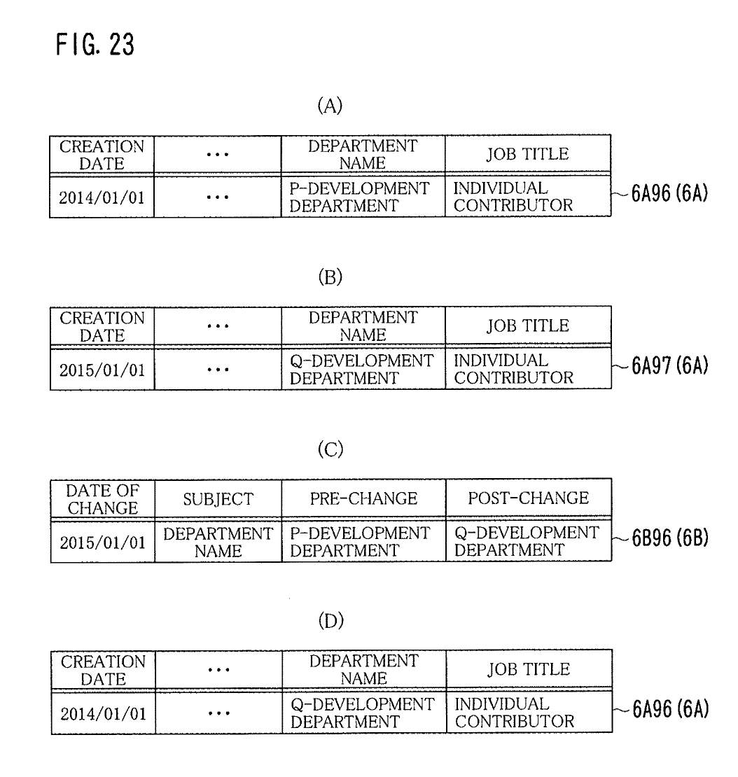

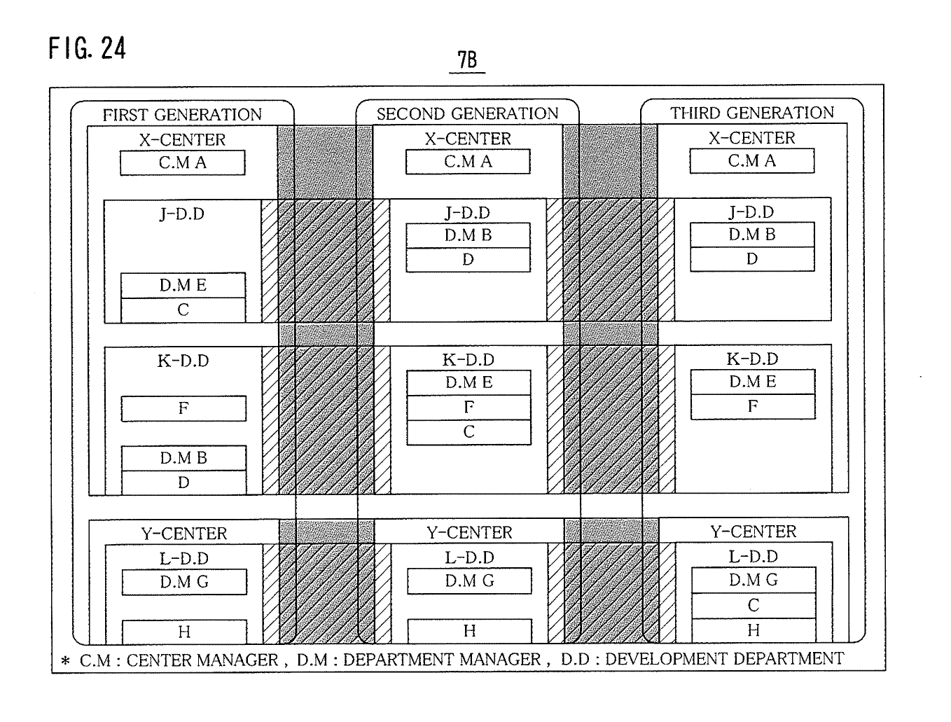

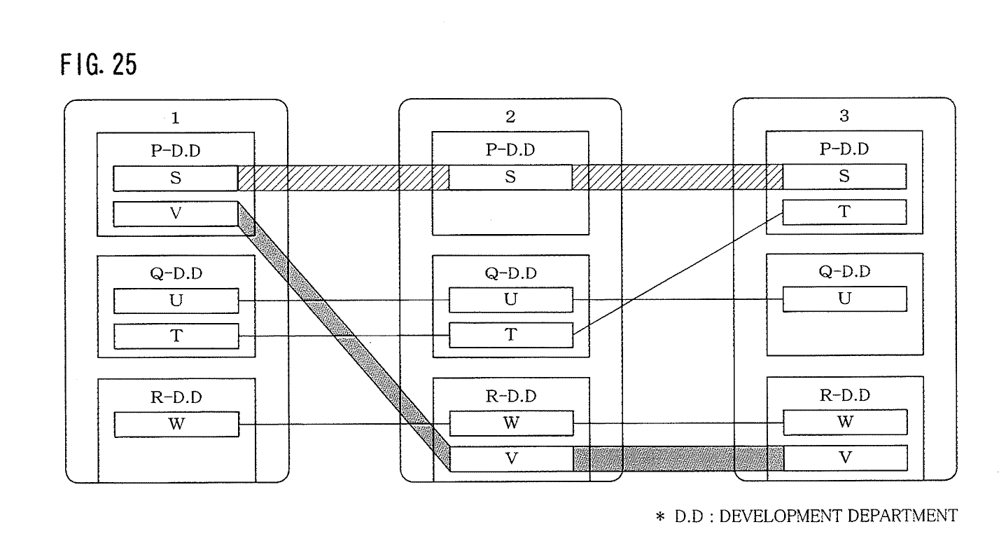

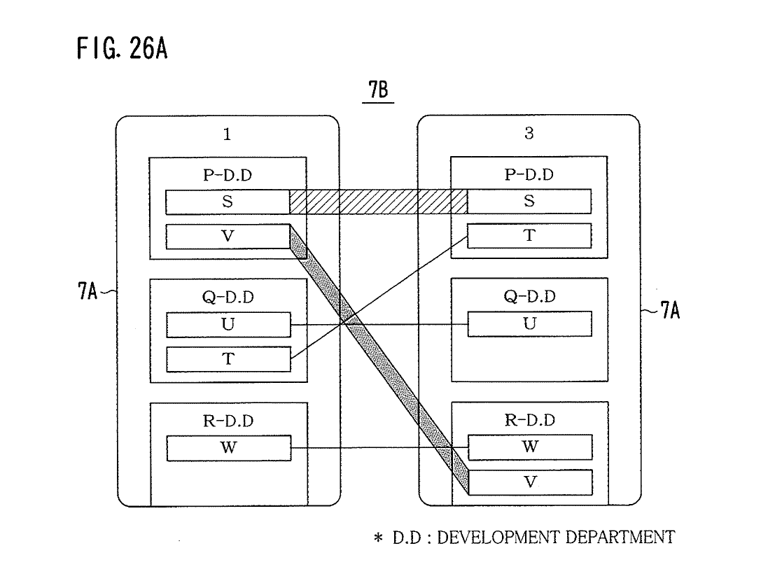

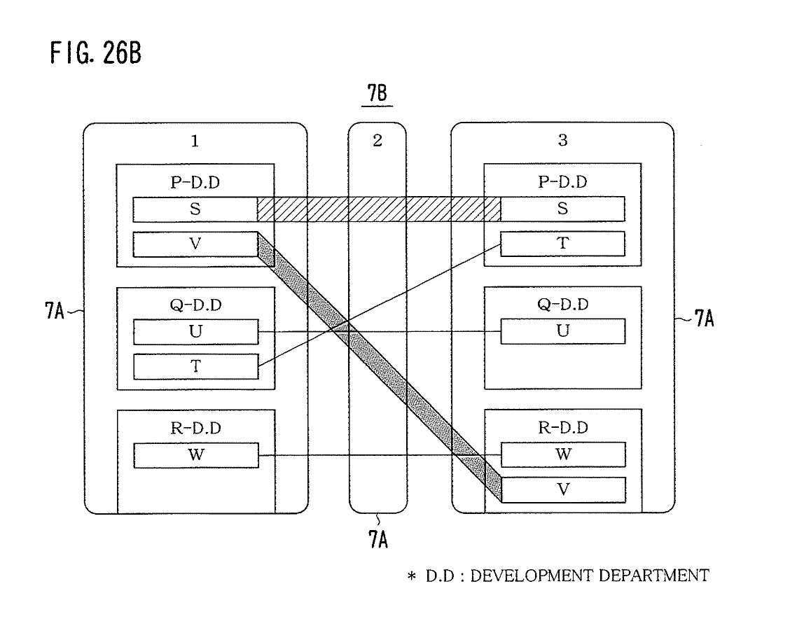

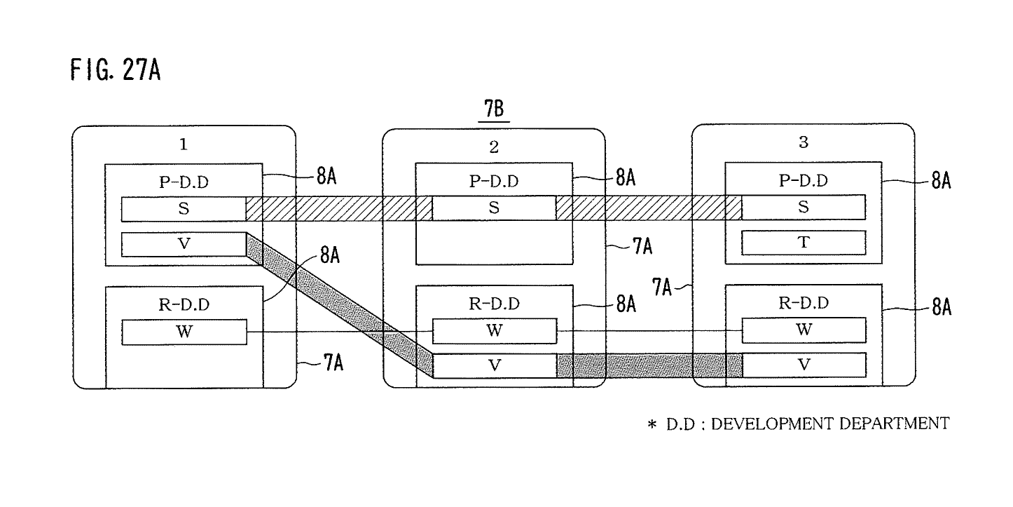

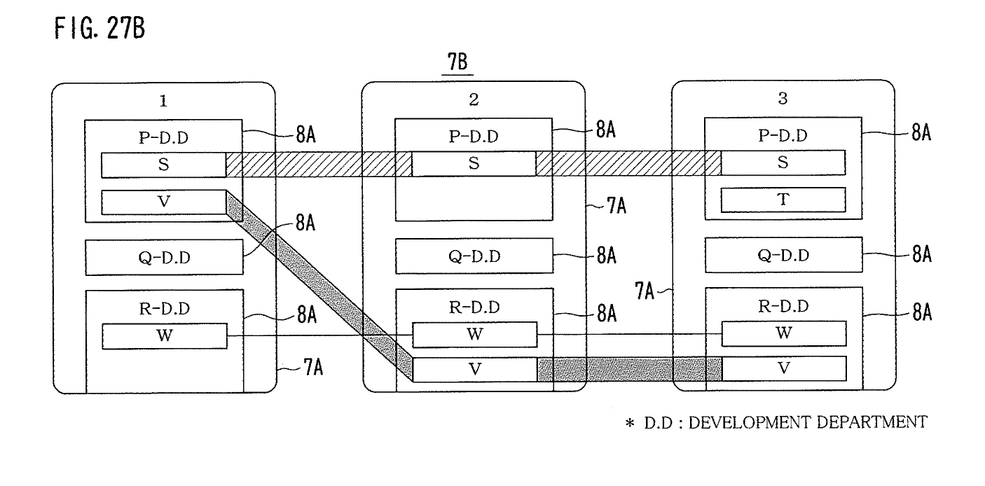

FIG. 23 is a diagram showing examples of personal data 6A and change information 6B for the case where a change is made to a department name. FIG. 24 is a diagram showing an example of a transition organizational chart 7B in which the first areas 8A are connected to each other and the second areas 8B are connected to each other. FIG. 25 is a diagram showing an example of a transition organizational chart 7B including an organizational chart 7A for an omissible generation. FIGS. 26A and 26B are diagrams showing an example of a transition organizational chart 7B with an organizational chart 7A for an omissible generation omitted. FIGS. 27A and 27B are diagrams showing an example of a transition organizational chart 7B with an organizational chart 7A for an omissible generation omitted.

In the foregoing embodiment, the description is provided by taking an example of data showing information on change in department of a person (namely, information on personnel change) as the change data 6B. Instead of this, however, the change data 6B may include information on change in department name. In such a case, the organizational chart generation portion 104 performs the processing as follows.

Before starting to create an organizational chart 7A for a particular generation, the organizational chart generation portion 104 searches, in the configuration table 6E for the next generation, for personal data 6A indicating a “pre-change” department name for the change data 6B. The organizational chart generation portion 104 temporarily replaces a department name indicated in the personal data 6A found by the search with a “post-change” department name of the change data 6B. The organizational chart generation portion 104 then creates the organizational chart 7A for the particular generation as discussed above. It is noted that the pre-change department name is placed in the second area 8B for the department name. After the creation, the organizational chart generation portion 104 restores the department name of the personal data 6A found by the search.

Suppose, for example, that the personal data 6A in the particular generation is personal data 6A96 on a person working in a P-development department as shown in (A) of FIG. 23; the personal data 6A in the next generation is personal data 6A97 on the person working in a Q-development department as shown in (B) of FIG. 23; and the change data 6B in the next generation is change data 6B96 indicating that the department name is changed from the “P-development department” to the “Q-development department” as shown in (C) of FIG. 23.

In such a case, the organizational chart generation portion 104 temporarily replaces the department name “P-development department” of the personal data 6A96 with the department name “Q-development department” indicated in the “post-change” of the change data 6B96 as shown in (D) of FIG. 23. At this time, the post-change department name may be emphasized by making the characters of the name in red, bold, or animate text so as to differ from the other department names in format.

While the example of change in department name is taken, a case of change in name and a case of change in location name may be subjected to the processing similar to that described above. In the case of change in name, the organizational chart generation portion 104 preferably performs the processing by temporarily replacing a name indicated in the personal data 6A with a “post-change” name of the change data 6B. In the case of change in location name, the organizational chart generation portion 104 preferably performs the processing by temporarily replacing a location name indicated in the personal data 6A with a “post-change” location name of the change data 6B.

In the foregoing embodiment, the linking portion 105 connects the adjacent node images 8N for the identical person. The linking portion 105 may further connect the adjacent first areas 8A for the same department with a line or a ribbon. Alternatively, the linking portion 105 may connect the adjacent second areas 8B for the same business site with a line or a ribbon. In order to facilitate visualization of the lines or the ribbons, no linking images 8 are shown in FIG. 24.

In the foregoing embodiment, the organizational chart generation portion 104 and the linking portion 105 create organizational charts 7A for all the generations. However, if the particular generation is a generation in which both the target and the source are remaining person (hereinafter, such a generation is referred to as a “omissible generation”), it is possible not to create an organizational chart 7A for the omissible generation. In such a case, the linking portion 105 preferably creates a transition organizational chart 7B by linking two node images 8N for the identical person to each other, supposing that no omissible generation is present.

Suppose, for example, that the processing is performed without omitting the organizational chart 7A for the omissible generation to create a transition organizational chart 7B as shown in FIG. 25, and that the target is denoted by “S” and the source is denoted by “V”. In such a case, the department in the third generation is the same as the department in the second generation for the target, and the department in the third generation is the same as the department in the second generation for the source. However, the department in the first generation is different from the department in the second generation for the source.

The organizational chart generation portion 104 therefore does not create the organizational chart 7A for the second generation. The organizational chart generation portion 104 creates the organizational chart 7A for the first generation, assuming that the first generation and the third generation are a sequence of generations. The linking portion 105 connects the two node images 8N for the identical person, assuming that the organizational chart 7A for the first generation and the organizational chart 7A for the third generation are next to each other. As a result, the transition organizational chart 7B shown in FIG. 26A is created.

Alternatively, the organizational chart generation portion 104 may create a transition organizational chart 7B on the assumption that no omissible generation is present and a transition organizational chart 7B including an organizational chart 7A for that generation, and may send, to the terminal 3, the transition organizational chart data 6F for each of the transition organizational charts 7B. The terminal 3 may display the two transition organizational charts 7B selectively in accordance with a command given by the user. This enables switching between display and non-display of the organizational chart 7A for the omissible generation.

Alternatively, the organizational chart 7A for the omissible generation may be created to differ from the organizational charts 7A for the other generations. For example, the organizational chart 7A for the omissible generation may have a background color of gray and the organizational charts 7A for the other generations may have a background color of white. Alternatively, as shown in FIG. 26B, the organizational chart 7A for the omissible generation may be represented only by the third area 8C and the generation name. At this time, the width of the third area 8C may be reduced.

Such processing is performed for the case where not the second generation but the first generation is the omissible generation. Consequently, as the transition organizational chart 7B, a transition organizational chart is created in which the transition organizational chart 7A for the first generation the first generation through the third generation among the organizational charts 7A is omitted.

According to the processing, where a department of a target is the same as a department of a source between two adjacent generations, an organizational chart 7A for an older generation of the two generations is omitted. However, it is possible to omit the organizational chart 7A for a newer generation instead of the organizational chart 7A for an older generation.

For example, where a department of a target is the same as a department of a source between the first generation and the second generation, and where any one of departments of the target and the source changes between the second generation and the third generation, the organizational chart 7A for the second generation may be omitted and the organizational charts 7A for the first generation and the third generation may be used to create the transition organizational chart 7B. In a similar fashion, where the department of the target is the same as the department of the source between the second generation and the third generation, and where any one of departments of the target and the source changes between the first generation and the second generation, the organizational chart 7A for the third generation may be omitted and the organizational charts 7A for the first generation and the second generation may be used to create the transition organizational chart 7B.

The omissible generation may be a generation in which not only the target and the source but also other person are remaining person.

In the foregoing embodiment, the organizational chart generation portion 104 creates the organizational charts 7A for all of the departments. Instead of this, however, the first area 8A for a department where neither the target nor the source has ever worked may be omitted. Alternatively, the second area 8B for a business site where neither the target nor the source has ever worked may be omitted.

For example, it is supposed that, after the processing is performed without omitting such a first area 8A, the transition organizational chart 7B shown in FIG. 25 is created. Further, it is supposed that the target is denoted by “S”, the source is denoted by “V”, and the target and the source have never worked in the Q-development department.

In such a case, the organizational chart generation portion 104 moves a part below the first area 8A for the Q-development department to be overlaid on the first area 8A for the Q-development department, and arranges the linking image 8L again, so that the transition organizational chart 7B is created again as shown in FIG. 27A. Alternatively, as shown in FIG. 27B, the organizational chart generation portion 104 may delete the node image 8N from the first area 8A for the Q-development department, reduce the height of the first area 8A for the Q-development department, move upward, by an amount corresponding to the height reduction, a part below the first area 8A for the Q-development department, and arrange the linking image 8L again, so that the transition organizational chart 7B may be created. Alternatively, the first area 8A for the Q-development department may be made different in configuration from the other first areas 8A. For example, the first area 8A for the Q-development department may be arranged to have a background color of gray and the other first areas 8A may be arranged to have a background color of white.

The terminal 3 may receive an input of both the transition organizational chart data 6F on the transition organizational chart 7B in which the first area 8A for the Q-development department is omitted and the transition organizational chart data 6F on the transition organizational chart 7B in which the first area 8A for the Q-development department is not omitted. The terminal 3 may display the two transition organizational charts 7B selectively in response to a command given by the user. This enables switching between display and non-display of the first area 8A for the Q-development department.

Alternatively, the transition organizational chart 7B may be created by omitting the first area 8A for a department where no personnel changes have been made, or the second area 8B for a business site where no personnel changes have been made.

In the foregoing embodiment, the linking portion 105 uses different linking images 8L (line or ribbon) for linking two node images 8N depending on a target, a source, and the other persons. For example, a red ribbon is used to link the two node images 8N for the target, a yellow ribbon is used to link the two node images 8N for the source, and a line is used to link the two node images 8N for the other persons. Further, different linking images 8L may be used for the case where a person is transferred to a different business site, where a person is transferred to a different department within a business site, or where a person is not transferred. For example, a solid-line ribbon may be used to link the two node images 8N to each other for the case of transfer to a different business site. A dot-dash line may be used to link the two node images 8N to each other for the case of transfer to a different department within a business site. A double-dot-and-dash line may be used to link the two node images 8N to each other for the case of no transfer. Alternatively, where a person is transferred to a different business site, or where a person is transferred to a different department within a business site, a line or a ribbon representing such a transfer may be reproduced in the form of animation Graphics Interchange Format (GIF).

In the foregoing embodiment, the specification data receiving portion 103 receives, as the specification data 6C, data designating both the target and the source. Instead of this, however, the specification data receiving portion 103 may receive data designating only one of the target and the source. Alternatively, the specification data receiving portion 103 may receive, as the specification data 6C, data designating a plurality of targets or a plurality of sources.

In the foregoing embodiment, the business card DB server 2B and the organizational chart creation server 2A are provided separately from each other. Instead of this, however, the business card DB server 2B and the organizational chart creation server 2A may be implemented as one device.

In the foregoing embodiment, the transition organizational chart 7B is outputted by sending the transition organizational chart data 6F to the terminal 3. Instead of this, however, the transition organizational chart 7B may be outputted by printing onto paper with an image forming apparatus, a printer, or the like.

In the foregoing embodiment, the organizational chart 7A for each generation is created with a period of 1 year set at one generation. Instead of this, however, one generation may correspond to a period having another length in light of circumstances in the organization. Alternatively, the time at which the organization established may be set as the first generation. In such a case, the second generation and beyond may be so set that one generation corresponds to a period from when a change (personnel change, new establishment of department, or elimination and consolidation, for example) occurs to when the next change occurs.

In the foregoing embodiment, the organizational charts 7A are arranged horizontally. Instead, the organizational charts 7A may be arranged vertically. In such a case, however, the first areas 8A for the identical generation are arranged horizontally, the second areas 8B for the identical generation are arranged horizontally, and the node images 8N for the identical generation are arranged horizontally. At this time, two node images 8N for a person who works at the identical department in two adjacent generations are so placed to be linked with each other by perpendiculars.

It is to be understood that the configuration of the organizational chart creation system 100, the organizational chart creation server 2A, the business card DB server 2B, the constituent elements thereof, the content of the processing, the order of the processing, the structure of the data, the structure of the organizational chart 7A, the structure of the transition organizational chart 7B, and the like may be appropriately modified without departing from the spirit of the present invention.

Although embodiments of the present invention have been described and illustrated in detail, it is clearly understood that the same is by way of illustration and example only and not limitation, the scope of the present invention should be interpreted by terms of the appended claims.

What is claimed is:

1. An organizational chart creation device comprising:
a hardware processor configured to create a transition organizational chart, the transition organizational chart including: a first organizational chart having first identifiers of first persons, who are in any of departments during a first period of time, classified and arranged according to department; a second organizational chart having second identifiers of second persons, who are in any of the departments during a second period of time, classified and arranged according to department; and a linking image for associating the first identifier and the second identifier with each other of a first person of the first persons and a second person of the second persons, said first person being identical to said second person, and to output the transition organizational chart.

2. The organizational chart creation device according to claim 1, wherein the hardware processor creates, as the transition organizational chart, a chart including: as the first organizational chart, an organizational chart in which a first department image showing, among the departments, a department present during the first period of time is arranged to set to correspond to the first identifier classified as the department present; as the second organizational chart, an organizational chart in which a second department image showing, among the departments, a department present during the second period of time is arranged to set to correspond to the second identifier classified as the department present; and a department linking image for associating the first department image and the second department image with each other, the first department image being identical to the second department image in department.

3. The organizational chart creation device according to claim 1, wherein the hardware processor creates the transition organizational chart in such a manner that: the first identifiers of the first persons are arranged in a first direction; the second identifiers of the second persons are arranged in the first direction; and, where the first person and the second person who are identical to each other among the first persons and the second persons are affiliated with a same department, the first identifier of the first person and the second identifier of the second person are arranged along a second direction orthogonal to the first direction.

4. The organizational chart creation device according to claim 1, wherein the hardware processor creates the transition organizational chart in such a manner that the linking image of a target person and the linking image of a source person are more noticeable than the other linking images, the target person being a person that a user wishes to contact among the first persons, and the source person being a person that the user is capable of directly contacting among the first persons.

5. The organizational chart creation device according to claim 4, wherein
the second period of time precedes the first period of time, and
where, in the departments, a first affiliation department of a second person who is identical to the target person of the second persons is different from a second affiliation department of the target person, or, alternatively, where, in the departments, a third affiliation department of a second person who is identical to the source person of the second persons is different from a fourth affiliation department of the target person, and further, where the first affiliation department is different from a fifth department of a third person who is identical to the target person of third persons, who are in any of the departments during a third period of time preceding the second period of time, or, alternatively, where, the third affiliation department is different from a sixth department of a third person who is identical to the source person of the third persons, the hardware processor creates, as the transition organizational chart, a chart further including a third organizational chart having third identifiers of the third persons classified and arranged according to department, and a second linking image for associating the second identifier and the third identifier with each other of a second person of the second persons and a third person of the third persons, said second person being identical to said third person.

6. The organizational chart creation device according to claim 5, wherein, where the first affiliation department is identical to the second affiliation department, the third affiliation department is identical to the fourth affiliation department, the first affiliation department is different from the fifth department, or the third affiliation department is different from the sixth department, the hardware processor creates a second transition organizational chart including the first organizational chart, the third organizational chart, and a third linking image for associating the first identifier and the third identifier with each other of a first person of the first persons and a third person of the third persons, said first person being identical to said third person, and excluding the second organizational chart, or, alternatively, the hardware processor creates a third transition organizational chart including the second organizational chart, the third organizational chart, and the second linking image, and excluding the first organizational chart.

7. The organizational chart creation device according to claim 5, wherein, where the first affiliation department is different from the second department or the third affiliation department is different from the fourth affiliation department, the first affiliation department is identical to the fifth department, and the third affiliation department is identical to the sixth department, the hardware processor creates the transition organizational chart without adding the third organizational chart and the second linking image, or, alternatively, the hardware processor creates a second transition organizational chart including the first organizational chart, the third organizational chart, and a third linking image for associating the first identifier and the third identifier with each other of a first person of the first persons and a third person of the third persons, said first person being identical to said third person, and excluding the second organizational chart.

8. The organizational chart creation device according to claim 4, wherein the hardware processor creates, as the transition organizational chart, a chart including
instead of the first organizational chart, an organizational chart having, among the first identifiers of the first persons, a first identifier classified, among the departments, as a department of the target person or of the source person, or, alternatively, a department of a person who is identical to the target person or the source person of the second persons so that the first identifier is classified and arranged according to department, and
instead of the second organizational chart, an organizational chart having, among the second identifiers of the second persons, a second identifier classified, among the departments, as a department of said identical person, or, alternatively, as a department of the target person or the source person.

9. An organizational chart providing system comprising:
a server; and
a terminal; wherein
the server includes
a hardware processor configured to create a transition organizational chart, the transition organizational chart including: a first organizational chart having first identifiers of first persons, who are in any of departments during a first period of time, classified and arranged according to department; a second organizational chart having second identifiers of second persons, who are in any of the departments during a second period of time, classified and arranged according to department; and a linking image for associating the first identifier and the second identifier with each other of a first person of the first persons and a second person of the second persons, said first person being identical to said second person, and
a transmitter configured to send the transition organizational chart to the terminal, and
the terminal includes
a receiver configured to receive the transition organizational chart from the server, and
a display device configured to display the transition organizational chart.

10. A transition organizational chart comprising:
a first organizational chart having first identifiers of first persons, who are in any of departments during a first period of time, classified and arranged according to department;
a second organizational chart having second identifiers of second persons, who are in any of the departments during a second period of time, classified and arranged according to department; and
a linking image for associating the first identifier and the second identifier with each other of a first person of the first persons and a second person of the second persons, said first person being identical to said second person.

11. A method for providing transition information related to transition in an organization including a plurality of departments, the method comprising:
creating a transition organizational chart including: a first organizational chart having first identifiers of first persons, who are in any of departments during a first period of time, classified and arranged according to department; a second organizational chart having second identifiers of second persons, who are in any of the departments during a second period of time posterior to the first period of time, classified and arranged according to department; and a linking image for associating the first identifier and the second identifier with each other of a first person of the first persons and a second person of the second persons, said first person being identical to said second person; and
outputting the transition organizational chart.

12. A non-transitory recording medium for storing a computer readable program used in a computer for providing transition information related to transition in an organization including a plurality of departments, the computer readable program controlling the computer to execute processing comprising:
creation processing for creating a transition organizational chart, the transition organizational chart including: a first organizational chart having first identifiers of first persons, who are in any of departments during a first period of time, classified and arranged according to department; a second organizational chart having second identifiers of second persons, who are in any of the departments during a second period of time, classified and arranged according to department; and a linking image for associating the first identifier and the second identifier with each other of a first person of the first persons and a second person of the second persons, said first person being identical to said second person; and
output processing for outputting the transition organizational chart.

13. The non-transitory recording medium according to claim 12, wherein the creation processing includes creating, as the transition organizational chart, a chart including: as the first organizational chart, an organizational chart in which a first department image showing, among the departments, a department present during the first period of time is arranged to set to correspond to the first identifier classified as the department present; as the second organizational chart, an organizational chart in which a second department image showing, among the departments, a department present during the second period of time is arranged to set to correspond to the second identifier classified as the department present; and a department linking image for associating the first department image and the second department image with each other, the first department image being identical to the second department image in department.

14. The non-transitory recording medium according to claim 12, wherein the creation processing includes creating the transition organizational chart in such a manner that: the first identifiers of the first persons are arranged in a first direction; the second identifiers of the second persons are arranged in the first direction; and, where the first person and the second person who are identical to each other among the first persons and the second persons are affiliated with a same department, the first identifier of the first person and the second identifier of the second person are arranged along a second direction orthogonal to the first direction.

15. The non-transitory recording medium according to claim 12, wherein the creation processing includes creating the transition organizational chart in such a manner that the linking image of a target person and the linking image of a source person are more noticeable than the other linking images, the target person being a person that a user wishes to contact among the first persons, and the source person being a person that the user is capable of directly contacting among the first persons.

16. The non-transitory recording medium according to claim 15, wherein
the second period of time precedes the first period of time, and
where, in the departments, a first affiliation department of a second person who is identical to the target person of the second persons is different from a second affiliation department of the target person, or, alternatively, where, in the departments, a third affiliation department of a second person who is identical to the source person of the second persons is different from a fourth affiliation department of the target person, and further, where the first affiliation department is different from a fifth department of a third person who is identical to the target person of third persons, who are in any of the departments during a third period of time preceding the second period of time, or, alternatively, where, the third affiliation department is different from a sixth department of a third person who is identical to the source person of the third persons, the creation processing includes creating, as the transition organizational chart, a chart further including a third organizational chart having third identifiers of the third persons classified and arranged according to department, and a second linking image for associating the second identifier and the third identifier with each other of a second person of the second persons and a third person of the third persons, said second person being identical to said third person.

17. The non-transitory recording medium according to claim 16, wherein, where the first affiliation department is identical to the second affiliation department, the third affiliation department is identical to the fourth affiliation department, the first affiliation department is different from the fifth department, or the third affiliation department is different from the sixth department, the creation processing includes creating a second transition organizational chart including the first organizational chart, the third organizational chart, and a third linking image for associating the first identifier and the third identifier with each other of a first person of the first persons and a third person of the third persons, said first person being identical to said third person, and excluding the second organizational chart, or, alternatively, the creation processing includes creating a third transition organizational chart including the second organizational chart, the third organizational chart, and the second linking image, and excluding the first organizational chart.

18. The non-transitory recording medium according to claim 16, wherein, where the first affiliation department is different from the second department or the third affiliation department is different from the fourth affiliation department, the first affiliation department is identical to the fifth department, and the third affiliation department is identical to the sixth department, the creation processing includes creating the transition organizational chart without adding the third organizational chart and the second linking image, or, alternatively, the creation processing includes creating a second transition organizational chart including the first organizational chart, the third organizational chart, and a third linking image for associating the first identifier and the third identifier with each other of a first person of the first persons and a third person of the third persons, said first person being identical to said third person, and excluding the second organizational chart.

19. The non-transitory recording medium according to claim 15, wherein the creation processing includes creating, as the transition organizational chart, a chart including: instead of the first organizational chart, an organizational chart having, among the first identifiers of the first persons, a first identifier classified, among the departments, as a department of the target person or of the source person, or, alternatively, a department of a person who is identical to the target person or the source person of the second persons so that the first identifier is classified and arranged according to department; and instead of the second organizational chart, an organizational chart having, among the second identifiers of the second persons, a second identifier classified, among the departments, as a department of said identical person, or, alternatively, as a department of the target person or the source person.
